(19) United States
(12) Patent Application Publication
(10) Pub. No.: US 2003/0198659 A1
(43) Pub. Date: Oct. 23, 2003

(54) Fibrous pest control

(76) Inventors: Michael P. Hoffmann, Ithaca, NY (US); Jeffrey Gardner, Hector, NY (US); Paul D. Curtis, Ithaca, NY (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/281,088

(22) Filed: Oct. 25, 2002

Related U.S. Application Data
(60) Provisional application No. 60/345,349, filed on Oct. 25, 2001.

(51) Int. Cl. A01N 25/34; B32B 27/04; B32B 27/12

(52) U.S. Cl. 424/411; 442/123

(57) ABSTRACT

The present invention provides fibrous pest deterrents that combine the useful properties of a physical barrier in the form of a non-woven fibrous matrix with a chemical deterrent such as a pesticide, behavior-modifying compound or a pest repellent. The use of such fibrous pest deterrents protects plants, animals and structures in both agricultural and non-agricultural settings from damage inflicted by pests. Unlike traditional pesticides, the behavior-modifying compound, pesticide or chemical deterrent of the present invention is adsorbed or attached to a fibrous matrix, and so it is not so readily dispersed into the environment. Hence, use of the present fibrous pest deterrents can reduce the levels of pesticides that inadvertently contaminate non-target areas and pollute water supplies. The present fibrous pest deterrents therefore help moderate in the use of pesticides in commercial agricultural and non-agricultural operations, home gardens, and the urban environment, alleviating public concerns about pesticide run-off, contamination of the environment and risks to human health.

This application is related to U.S. Application Ser. No. 60/345,349 filed Oct. 25, 2001.

### GOVERNMENT SUPPORT

This work was supported in part by Cornell University Agricultural Experiment Station federal formula funds, Project No. NYC-139488 and grants from U.S. Department of Agriculture, Cooperative State, Research, Education, and Extension Service (USDA-CSREES) Pest Management Alternatives Program (PMAP) [Cooperative Agreement 97-34365-5003] and the Environmental Protection Agency, Pesticide Environmental Stewardship Program (PESP) [Cooperative Agreement No. X99274010]. The government has certain rights in the invention.

### FIELD OF THE INVENTION

The invention pertains to the control of pests through the use of fiber barriers that can have behavior modifying agents, pest deterrents or related agents adsorbed or cross-linked to the fiber matrix. Pests deterred by the fiber barriers of the invention can be any type of invertebrate or vertebrate pest known to adversely affect humans, cultivated plants, domestic animals or the environment.

### BACKGROUND OF THE INVENTION

With the proliferation of chemical insecticides in the 1950s, easy control of insect pests appeared to be at hand. However, it soon became obvious that there were significant problems associated with the use of pesticides. Through several decades of use, over 500 different arthropod pests have become resistant to insecticides. Several species of plant pathogens and weeds have also developed resistance to pesticides. In addition, widespread environmental and health hazards have been associated with the massive use of pesticide compounds. Many non-target organisms have been adversely affected, and pest resurgence has often occurred because broad-spectrum pesticides have eliminated the natural enemies that had originally helped to keep pest populations in check. To date, however, the protection of agriculturally valuable food crops and other plants from insect, mite, disease, weed, and vertebrate pests in conventional agricultural systems, primarily relies on the continued use and commercial availability of chemical pesticides. Likewise, pesticides are relied upon in the urban and suburban environment to control innumerable structural and landscape pests and to protect humans from diseases such as those vectored by insects. Continued reliance solely on conventional pesticides is a questionable strategy for sustained pest management. Therefore, alternative strategies for the protection of economically or aesthetically valuable plants, structures, and human health are needed.

Current alternatives to conventional pesticides include the strategies promoted by Integrated Pest Management (IPM) programs. These IPM programs advocate the development of biological, cultural, physical and mechanical controls, engineered and inherent host plant resistance, as well as the use of naturally occurring aversive compounds to replace and/or complement the use of pesticide compounds. This is done with an eye toward minimizing risks to the environment and human health. Much of the emphasis in these programs has been placed on the development of biological and cultural control elements because of increasing resistance by pests to pesticide controls.

However, interest in and development of physical and mechanical barriers and repellents has lagged. Physical controls include the use of heat, sound, light, and radiation to kill pests. Mechanical control techniques include the use of handpicking, traps, screens, barriers, sticking agents, and sticky bands. While some of these techniques are laborious and therefore economically unsuitable for situations other than home gardens, the use of physical barriers can be easily mechanized and made suitable for large-scale farming, as well as for home gardens. Some types of barriers have been used to prevent insect pests from reaching crops. Row covers and reflective mulches have been used extensively to prevent insects from locating crops, either through visual disorientation or acting as simple barriers, as well as for horticultural purposes (Burbutis, P. P., and Lesiwicz, D. S., 1973; Chalfant et al., 1977; Schalk et al., 1979; Wells and Loy 1985; Perring et al., 1989; and Conway et al., 1989). The use of “trenches” for the trapping of Colorado potato beetles has reportedly been effective (Moyer 1993). This is a simple, environmentally sensitive, and cost-effective method of controlling Spring and Fall dispersing adult potato beetles that can reduce the need for insecticide use against these pests.

Currently, there are few alternatives to the use of insecticides for the effective control of the corn earworm in sweet corn. The release of biological control agents, such as Trichogramma are typically not effective (Oatman 1966) and are clearly incompatible with current heavy insecticide use patterns. Silk clipping (Carruth 1936) or application of the biological control agent Bacillus thuringiensis in combination with mineral oils can be effective but have only been practical on small acreages. Several types of pest/crop situations should be amenable to control by pesticide-fiber barriers, including: (1) moths which lay their eggs directly on the plant surfaces, (2) maggot adults (flies) which lay their eggs in the soil at the base of the plants, (3) beetles which feed directly on the newly emerged foliage, and (4) molluscs that creep up the stem of the plant.

For example, female corn earworm moths deposit up to 85% of their eggs directly on the silks of silking corn. It is very difficult to control the larvae that develop from these eggs because they quickly bore through the silks and into the ear, where they are protected from most insecticides. Frequent applications of insecticides are required to kill larvae during the 2 to 3 week larval period when ears are most susceptible to damage from this pest. For example, on Long Island, where corn earworm and related Lepidopteran insect infestations are the most severe in New York State, it is not unusual for growers to make 12 to 14 insecticide applications per planting. Such insecticide application is frequently at two to three day intervals during the silking stage of sweet corn development, and reflects an extremely heavy and expensive investment in the use of chemicals. Similar insecticide use patterns are also common in many other areas, especially in those areas economically dependent upon agricultural production. In Florida, sweet corn fields in silk during peak flights of corn earworm can be treated with 20 or more applications of insecticide over the developmental period of the corn (Mitchell 1978). This heavy insecticide use leads to high ecological and economic costs, and has lead to secondary pest outbreaks of two-spotted spider mites (Pike and Allison 1987). The development of insecticide resistance in target pests is a continuing and growing threat to successful pest control around the world (Straub and Emmett 1992). Alternatives to such heavy use of insecticides in corn are therefore needed.

Insect pests which lay their eggs at the base of the plant and whose larvae feed on the roots of seedlings are particularly troublesome to growers and usually require prophylactic treatment with synthetic insecticides to the base of the plant or incorporated into the soil at planting to combat crop loss. Such applications are often subject to leaching and are of concern for ground water contamination. The primary pests that attack crop roots are the various species of maggots. Adult flies are normally attracted to the plant species by visual and chemical cues and lay their eggs at the base of the stem. Larvae develop from the eggs and burrow into the roots. Examples include the cabbage maggot, which feeds on a host of cruciferous crops (broccoli, cabbage, cauliflower, etc.), the onion maggot, which feeds on onions and closely related crops, and seed corn maggots, which feed on a host of crops including beans and corn. Damage to seeds and roots from these pests may result in death of the plant, diminished yields, or unmarketable roots (i.e. turnips).

The cabbage maggot, Delia radicum (L.), and the onion maggot, Delia antiqua (Meigen) (Diptera: Anthomyiidae), are serious worldwide pests of cruciferous and Allium crops, respectively (Finch 1989). They are particularly damaging in the northeastern U.S. and Canada, where several generations occur each season. Crops attacked by cabbage maggots include, cabbage, broccoli, cauliflower, radish, turnips, kale, collards, and Brussels sprouts (Finch and Thompson 1992). Onion maggots attack onions, garlic, chives, shallots and leeks (Straub and Emmett 1992). Adults of both species lay their eggs near the base of plants and emerging larvae (maggots) infest the underground structures of plants. When infested in the seedling stage, plants may wither and die. Secondary decay can occur in the maggot feeding area, which can result in infection by pathogenic organisms, such as Fusarium spp. (McDonald and Sears 1992). With heavy infestations, up to 90% of plants may be destroyed by cabbage maggot unless control measures are taken (Finch and Thompson 1992). Losses of untreated onion plants to D. antiqua are estimated to be about 24-40% (Finch 1989).

Growers rely heavily on the use of insecticides for control of both cabbage and onion maggots. Fields are treated prophylactically with soil insecticides (granules, seed treatments, and soil drenches) at planting to control the first generation of maggots. Foliar insecticide sprays for adults are used to control subsequent generations (Finch et al. 1986a), but often are not effective (Whitfield et al. 1985; Finch et al. 1986b). Both cabbage maggots and onion maggots have become resistant to a wide range of insecticides (Carroll et al. 1983; Harris and Svec 1976; Harris et al. 1988); and relatively few compounds remain effective for control of these pests (Hayden and Grafius 1990; Finch and Thompson 1992). Furthermore, registration of most of the currently used compounds (organophosphates and carbamates) could be lost in the United States pending regulatory action of the Food Quality Protection Act of 1996 (Stivers 1999a; and 1999b). Thus, the need for alternative control measures for cabbage maggot and onion maggot is-critical.

Because D. radicum and D. antiqua lay their eggs at the base of plants and require tactile stimulation with the plant prior to oviposition (Finch 1980; Prokopy et al. 1983; Harris and Miller 1991) the use of physical barriers has been investigated as a control measure for these pests. Successful results have been shown with crop-protecting covers and collars placed around the base of the plant (Skinner and Finch 1986; Matthews-Gehringer and Hough-Goldstein 1988; Evans et al. 1997) and with hydromulch applications (Liburd et al. 1998). Most of these approaches are expensive, labor intensive, difficult to dispose of, or pose problems for plant development and pollination (Finch 1989). Hence, new methods are needed.

Similarly, there currently are limited options for controlling terrestrial molluscs in agricultural, urban and home garden settings. Certain insecticides and inorganic formulations of copper are effective, but wholesale release of these agents into the environment may be undesirable. Molluscs have also been discouraged from creeping up plants (e.g., citrus, grapes, vegetables) by use of elemental copper strips that surround plants. But such treatment can be expensive.

Cucumber beetles are the most important direct feeding pests of the cucurbits (cucumber, squash, pumpkin, etc.). These pests are especially difficult for organic growers to control because of their limited options. Colorado potato beetles feed directly on a number of solanaceous crops including tomatoes and potatoes. These pests feed on the newly emerged, and very susceptible plants. New means of disrupting the ability of such pests to find or feed on the leaves or root system of a marketable product are needed.

Many crops, including cherries, blueberries, strawberries, and sweet corn are plagued by bird pests. Birds are major pests of sweet corn production because they feed extensively on the ear tips, making the entire ear unmarketable. For example, red-winged blackbirds are one of the most abundant bird species in North America (Dolbeer and Stehn, 1983), and annually destroy substantial amounts of sweet corn (Dolbeer, 1990). Three studies in five states reported mean sweet corn loss per field of 5.6% (Dolbeer et al., 1976), 18% (Knittle et al., 1976), and 36% (Mott, 1976) (57 fields in total). A combination of factors accounts for high bird damage. During late summer, when sweet corn ears are vulnerable to depredation, roosting flocks may contain several million blackbirds, and most foraging occurs within 10 km of roost sites (Dolbeer, 1990). If sweet corn is available within this distance, it can comprise up to 81% of the red-winged blackbird's diet (Hintz and Dyer, 1970). Furthermore, even slight damage to the kernels can result in an unmarketable product (Dolbeer, 1990).

A variety of methods to reduce damage by such blackbirds have been tried, including the use auditory and visual frightening devices, chemicals, cultural practices, and the planting of resistant cultivars (Conover, 1984; Dolbeer, et al., 1986; Dolbeer, et al., 1988; Conover and Dolbeer, 1989; Curtis et al., 1993; Askham, 2000). Although Avitrol® and hawk kites may provide adequate protection for some fields (Conover, 1984), their cost is prohibitive.

Mechanical barriers such as netting have been used for reducing bird damage to agricultural products such as fruit and vegetable crops (Himelrick, 1985). However, the high cost of materials and difficulty of applying and removing netting have limited the use of this type of barrier to small-scale gardens or research plots. While Fuller-Perrine and Tobin (1992) have developed cheaper methods for applying netting to trellised vineyards, no practical netting techniques exist for the protection of fruit or vegetable crops on a commercial scale.

Most barriers to bird feeding that have been investigated to date have been of a solid design (i.e., sheets of woven material, plastic mulches, wire cages, bud caps, etc.), but such solid barriers can block sunlight penetration, pollination, and water movement necessary for appropriate plant development. In addition, disposal of solid barriers can be a problem. Thus, other types of pesticide barriers, which allow sunlight penetration and pollination and do not adversely affect plant growth, are preferred for pest control.

Work with pest barriers has mainly been directed at disease-vectoring pests (i.e., aphids) using various woven fabric-type materials and reflective mulches or row covers (see references above). For example, Yudin et al., (1991) investigated the effects of barriers on the distribution of thrips in lettuce and Hough-Goldstein (1987) studied the effectiveness of spun polyester as a barrier against seed corn maggot and Lepidopteran pests of cabbage. However, new materials and methods are needed to optimally control the diversity of pests that plague the environment.

### SUMMARY OF THE INVENTION

The present invention provides fibrous pest deterrents that can have pesticides or pest behavior-modifying compounds stably adsorbed thereto. Such fiber barriers can be applied directly to plants, structures, animals and even to humans to provide relief from pest infestations. The fiber barriers can be selectively applied to various parts of a plant, animal or structure. Alternatively, the fiber barriers can be applied to a whole plant, animal or structure, or placed around the plant, animal or structure. One advantage of the present fiber barriers is that they can readily be removed after use so that any adsorbed pesticide or behavior-modifying compound is also removed. Hence, the pesticide/compound is retained with the removable fibrous material and pest protection can be achieved without release and build-up of chemical pesticides or other agents in the soil, air or environment.

In another embodiment, the fiber is biodegradable and the adsorbed pesticide, herbicide or other pest deterrent can be slowly released into a localized area of the environment to control pests in that area over a period of time. The fibrous pest deterrents of the invention can be used wherever a need exists for protection from pests, for example, in both agricultural and non-agricultural environments.

In one embodiment, the pesticide fibers are non-woven and can be sprayed onto plants, animals, and structures or onto the ground surrounding the plants to discourage (or kill) pests from occupying their usual site of infestation on the plants, animals, and structures or within the soil. The pesticide fibers can be electrostatically spun, melt-extruded and otherwise extruded as physical barriers and deterrents for the protection in a wide variety of situations against diverse types of pests.

The present invention further provides a method of reducing damage done by pests, which includes applying an effective amount of a fibrous pest deterrent onto or in the vicinity of an animal, plant or structure such that the fibrous pest deterrent inhibits damage otherwise inflicted to the animal, plant or structure to be protected. Such a fibrous pest deterrent includes a loosely arranged fiber that can have a behavior-modifying or deterrent compound stably adsorbed or attached to the fiber. Examples of such behavior-modifying or deterrent compounds are:

a) a pesticide;

b) a fungicide;

c) an herbicide;

d) an insecticide;

e) a molluscide;

f) behavior modifying compound for a natural enemy of the pest or pests to be inhibited or eliminated;

g) a sensory (visual, olfactory, tactile) repellent for the pest or pests to be inhibited;

h) a behavior modifying compound for the pest or pests to be inhibited; or

i) a biological control agent for the elimination or reduction of a given pest.

The present invention also provides a method of reducing the damage done by pests, which includes applying an effective amount of a fibrous pest deterrent onto or around an animal, plant or structure to be protected such that the fibrous pest deterrent inhibits damage otherwise inflicted to the animal, plant or structure to be protected, wherein the fibrous pest deterrent includes a compound which is visually repellent to pests due to said compound's visible characteristics. In one embodiment the fibrous pest deterrent is visible to pests in the ultraviolet light region of the electromagnetic spectrum. In another embodiment, the fibrous pest deterrent is capable of simulating the ultraviolet spectrum patterns of a plant species upon which target pests do not feed.

Modifications of the fibrous pest deterrent concept will create more creative and extensive applications, including the addition of a sticky agent to the fibers, the use of spider silk fibers (e.g. or other biological compounds), and using larger fibers to simulate oviposition substrates (i.e., corn silk), or using fiber types that vary in their compositions together for an application. Considering the well-documented problems associated with conventional pesticides, this novel type of pest control promises exceptional results for agribusiness and the urban environment. The advantages of this environmentally benign tactic are many. For example, the use of fiber barriers to control the corn earworm in sweet corn could dramatically reduce insecticide inputs into this widely grown and valuable crop and can prevent damage by deer to a variety of plants, providing increased harvests and substantial savings annually.

### DESCRIPTION OF THE DRAWINGS

FIG. 1 graphically illustrates the number of slugs in baited areas after placement of copperized fabric.

FIG. 2 graphically illustrates the number of slugs in peas protected by a non-woven fiber fabric with copper granules affixed.

FIG. 3 graphically illustrates the effect of capsaicin (1:6 ratio) and ethylene vinyl acetate (EVA) fiber treatments on cabbage maggots in broccoli plants in a small-plot field experiment conducted near Freeville, N.Y. Treatment regimens are identified below the graph. Bars with the same letter are not significantly different according to Fisher's protected LSD at the 0.05 level of significance.

FIGS. 4A and 4B provide photographs of typical ears of treated and untreated sweet corn after exposure to blackbirds. FIG. 4A provides a photograph of an ear of sweet corn that was sprayed with obstructive non-woven fiber and then exposed to blackbirds. FIG. 4B provides a photograph of an untreated (control) ear of corn after exposure to blackbirds.

FIG. 5 illustrates the percent damage by deer over time to bean plants at the Indelicato test site. Bean plants at this site received the different treatments. As illustrated, control plants that received no treatment sustained the greatest damage (about 100% by day 15). Plants treated with Hinder (a commercial deer repellent), but that received no fibrous barriers, also sustained large amounts of damage (about 90% by day 31). In contrast, plants receiving any form of EVA fiber barrier treatment (EVA only, EVA/BGR, and EVA/Oleoresin) sustained significantly less damage over time (e.g., less than 5% for EVA-only and EVA-Oleoresin treatment up to day 33 and about 20% damage for EVA-BGR treatment up to day 33).

FIG. 6 illustrates the percent damage by deer over time to bean plants at the Soltys test site. Bean plants at this site received the different treatments. As illustrated, control plants that received no treatment sustained the greatest damage (over 80% by day 33). Plants treated with Hinder (a commercial deer repellent), but that received no fibrous barriers, also sustained large amounts of damage (over 60% by day 33). In contrast, plants receiving any form of EVA fiber barrier treatment (EVA only, EVA/BGR, and EVA/Oleoresin) sustained significantly less damage over time (e.g., less than 10% for EVA-only treatment up to day 25 and less than 30% damage for EVA-only treatment up to day 33). In this study, the EVA-BGR and EVA-Oleoresin appeared to provide some benefit later in the study but these results were not statistically significant in part because of the low number of time points.

### DETAILED DESCRIPTION OF THE INVENTION

The invention provides fibrous pest deterrents that can discourage a variety of pests from injuring plants, animals, structures and humans. Pests that can be prevented from injuring such plants, animals, structures and humans include both vertebrate and invertebrate pests.

In other embodiments, the invention provides non-woven fibrous deterrents that include fibers with pesticides or pest behavior-modifying compounds stably adsorbed or linked thereto. The fibers work with the pesticides and other compounds to obstruct or discourage egg laying, feeding, pest reproduction, biting, stinging or the spread of vectorable diseases by pests. Moreover, the pesticide or pest deterrent can remain bound to the fibers, so that removal of the fibers removes the pesticide/deterrent from the environment. Therefore, the present fibrous deterrents can provide a combined chemical and mechanical barrier effective for management of pests.

Examples of Plants, Animals and Structures that can be Treated

The fibrous compositions of the invention can be used on any type of plant, animal or structure. For example, the fibrous compositions can be used on agricultural, horticultural, decorative, or other plants. The fibrous compositions can be used on crops, trees, seedlings, forests, fields, gardens, shrubs, flowering plants and other types of plants cultivated by persons interested in preventing injury to such plants. The fibrous compositions can also be used on any type of animal that may be exposed to an undesirable pest. Such animals include, for example, cattle, horses, sheep, goats, pigs, chickens, turkeys, geese, rabbits, dogs, cats, and humans. Moreover, the fibrous compositions can be used on any type of structure. For example, the fibrous compositions can be used on any domestic, commercial or industrial structure. Examples of such structures include homes, barns, silos, grain elevators, poultry barns, factories, hospitals, prisons, restaurants, military barracks, military installations, storage facilities, tents, campsites, and other types of structures in need of pest barriers.

The present fibrous deterrents can be used in any environment including any agricultural, horticultural, rural, natural, urban, structural, storage, transport or other situations where pests can potentially harm plants, dwellings, soil, humans or animals. For example, the fibrous deterrents of the present invention can be used on field crops, in greenhouses, in nurseries, on livestock, on pets, on humans, in the home and in home yards and gardens. In agriculture, the fibrous deterrents of the invention can be used to discourage pest infestation in multiple cropping systems including field crops, greenhouse production, animal husbandry and nurseries. In the nonagricultural environment, the invention is applicable in urban settings including home gardens, home attics, home foundations, public and private landscapes, arboretums, warehouses, cargo containers, ships' holds, freight cars, conservatories, and arboreal settings where pest control may be needed. The present invention can be used to treat and protect newly seeded and growing crops, seedlings, ornamentals as well as portions of plants such as the roots, flowers, stems, fruits and vegetables of plants. The present invention can be used to treat and protect harvested crops in silos, barns and other storage facilities.

The present fibrous compositions can be used as pond or pool coverings, for example, to block algae growth or to allow slow release of an agent such a Bacillus thuringiensis for mosquito control.

In one embodiment, the present fibrous compositions can be sprayed onto livestock and horses to protect them from biting insects. The present fibrous deterrents can be used to protect humans from insects such as gnats, flies, ticks, bees, wasps and mosquitoes.

In one aspect, the present fibrous deterrents act as a physical barrier to prevent pests from reaching the plant, animal or structure. In this aspect, the fibrous deterrents of the present invention mimic spider webs and can be used with or without an adhesive and with or without a toxicant (pesticide) or behavior-modifying compound. Insects become entangled in the “web” and, when an adhesive is used, the insect will remain stuck to the web. When used with an insecticide or other toxicant, even pests that escape the fibrous web have small amounts of toxicant stuck to them, which can kill or disable the pest from further destructive activities. Full or dense coverage can be provided or less dense coverage, for example, like that of a spider web, can be used. When the fibrous deterrent is lightly administered, weak fliers cannot reach the plants, for example, aphids, thrips, leafhoppers, and fungus gnats. In denser form, the present fibrous deterrents can replace currently used ‘row covers’ and early season pests that infect small and transplanted plants can be treated with the present invention.

The present fibrous deterrents can also be applied to selected parts of plants so that pests are discouraged from reaching the part of the plant that they typically infest. For example, the present fibrous deterrents can be applied to the growing tips of trees (such as mahogany and pine seedlings), to developing cotton bolls to prevent bollworm complex, to developing fruits and vegetables such as beans, corn, artichokes (plume moth) and the like.

In another aspect, the present fibrous deterrents are used to simulate oviposition substrate, for example, the present fibers simulate corn silk and female moths lay eggs on the fiber instead of the corn silk. In this aspect, the present fibrous deterrents are useful against the corn earworm and can be used, for example, on sweet corn and seed corn.

Pests

The present invention contemplates treatment or prevention of infestation by any pest. Hence, the present fibrous pesticides and deterrents can be used with any insect or pest known to be detrimental to humans, animals, structures, crops, ornamental plants, grasses and other cultivated plants. Such insects and pests include those discussed in this application as well as those known to one of skill in the art. Thus, all kinds of pests can be blocked or deterred, including insects, molluscs (e.g., slugs and snails), birds, rodents, small mammals, large mammals, herbivores and the like.

The invention contemplates protection of urban settings, buildings, agricultural structures and domestic structures against pests such as termites, roaches, ants, carpenter ants, fleas, mice, rats, squirrels, birds and the like. In other embodiments, the compositions and methods of the invention can be used to treat and protect agricultural buildings from pests such as mice, rats, birds, foxes and the like.

The present fibrous deterrents can be used for bird control or to change birds' behavior. Such birds include any arthropod-eating, mollusc-eating, fish-eating, seed-eating, nut-eating or fruit-eating bird. Examples of such birds include American robins, blackbirds, Canada geese, crows, finches, grackles, pigeons, seagulls, sparrows, starlings, woodpeckers, and the like. In one embodiment, complex sugars are adsorbed or attached to the present fibrous deterrents. Such complex sugars act as repellents for birds. The sprayable fibers of the invention can also incorporate a chemical or visual deterrent. For example, ultraviolet light enhancers in the fibers can be used to disrupt bird foraging behavior. Use of the present fibrous deterrents in this manner, for example, will protect blueberries, sweet corn, cherries, grapes, strawberries, ornamental bushes, nurseries and tree seedlings.

Fiber deterrents of the invention can also be modified to include repellents such as methyl anthranilate (MA), a nontoxic sensory repellent that is aversive to many bird species (Cummings et al., 1991; Dolbeer et al., 1992; Curtis et al., 1994; Askham, 2000), or mint extract (Avery et al., 1996). In other embodiments, colored fibers can be used. Captive red-winged blackbirds avoided blue colored rice seed in feeding trials (Avery et al., 1999). Blue-colored fibers may also deter blackbirds from damaging plants, fruits, grapes and crops more effectively than white fibers.

The invention can also be used to discourage foraging herbivores from injuring or consuming plants in the garden, in the field or in other settings. Such foraging herbivores include white-tailed and mule deer, elk, rabbits, groundhogs, gophers and the like.

Animals and humans can be protected from mosquitoes, flies, fleas, wasps, bees, ticks, leeches and other creeping, crawling or flying pests. Colored fiber barriers of the invention can also be applied to animals and humans as a form of camouflage to not only protect the animal or human from pests but to disguise the animal or human, for example, during hunting, bird-watching or observance of animals in their native habitat.

Examples of insects against which the present invention is effective include the corn earworm (both sweet and seed corn), the diamondback moth (cabbage/transplants), maggot pests (onion and cabbage), cucumber beetles, Colorado potato beetle, aphids, corn rootworm, and the like. Other pests that can be deterred from injuring a human, plant, animal or structure include striped cucumber beetles (Acalymma vittatum), spotted cucumber beetles (Diabrotica undecimpunctata howardi), Colorado potato beetle (Leptinotarsa decemlineata), flea beetles (Epitrix spp.), D. undecimpunctata howardi, diamondback moth (Plutella xylostella), corn earworm (Helicoverpa zea), silverleaf whitefly (Bemisia argentifoli), imported cabbageworm (Pieris rapae), and cabbage maggot (Delia radicum). The present invention also provides a method of reducing plant damage by pests, which includes applying an effective amount of a fibrous pest deterrent onto a plant or animal, wherein the fibrous pest deterrent comprises a pest deterrent stably adsorbed or attached to a fiber, and wherein both the pest deterrent and the fiber inhibit a pest from damaging the plant or animal. The pest can be any pest known to one of skill in the art. For example, the pest can be:

a) insects in the order Coleoptera;

b) insects in the order Lepidoptera;

c) insects in the order Diptera;

d) insects in the order Homoptera;

e) insects in the order Isoptera;

f) insects in the order Hemiptera;

g) insects in the order Orthoptera;

h) insects in the order Thysanoptera;

i) slugs in the phylum Mollusca;

j) snails in the phylum Mollusca;

k) insects in the order Mallophaga; or

l) insects in the order Siphonaptera.

Specific examples of pests that can be deterred by the fibrous deterrents of the invention include:

a) Striped Cucumber Beetles (Acalymma vittatum);

b) Spotted Cucumber Beetles (Diabrotica undecimpunctata howardi);

c) Northern Corn Root Worms (Diabrotica barberi);

d) Western Corn Root Worms (Diabrotica virgifera);

e) Colorado Potato Beetle (Leptinotarsa decemlineata);

f) Flea Beetles (Philotreta spp., Epitrix spp.);

g) Diamondback Moth (Plutella xylostella);

h) Corn Earworm (Helicoverpa zea);

i) Cabbage Maggot (Delia radicum);

j) Seed Corn Maggot (Delia platura);

k) Onion Maggot (Delia antiqua);

l) Cotton Bollworm (Heliothis virescens);

m) Pink Bollworm (Pectinophora gossypiella);

n) Silverleaf Whitefly (Bemisia argentifolii);

o) Imported Cabbageworm (Pieris rapae);

p) Fungus Gnats (Mycetophilidae spp.);

q) Brown banded slugs and gray garden slugs; and

r) Ants (Hymenoptera: Formicidae).

Fibers

Any fiber material that can readily be laid down, sprayed or applied to plants, animals or structures can be used for the present fibrous deterrents. In some embodiments, the fiber can have a behavior-modifying compound or pest deterrent stably adsorbed or linked thereto. Fibrous barriers can be composed of biodegradable or non-biodegradable polymers.

Fiber polymers for use in the fiber deterrents of the invention can include, for example, low density polyethylene, high density polyethylene, vinyl acetate, urethane, polyester, silicone, neoprene, disoprene and mixtures thereof. Other examples of materials from which the fibers of the invention can be made include acrylic acids, alyplastic glycols, aromatic acids, chemically treated polyethylene, chemically treated polypropylene, chemically treated polyurethane, poly (lactide-co-glycolide), polylactic acid, polyamides, polyanhydrides, polycaprolactone (PCL), polycarbonate, polydioxanone (PDO), polyester, polyester-water dispersible, polyether-block copolyamide, polyethylene (nylon), polyethylene oxide (PEO), polyglycolides (PGA), polyhydroxyalkanotes (PHAS), polylactides (LPLA) (DPLA), polyolefin, polyolefins, polyorthoesters, polyoxyethylene, polypropylene, polystyrene, polytrimethylene, perephthalate (PTT), polyvinyl-pyrrolidone (PVP), polyvinylchloride (PVC), rayon-non dispersible, or starch based resins.

Fibrous barriers can also be composed of biodegradable polymers such as Elvaloy® (DuPont™), that is chemically similar to Elvax®, but that contains carbon monoxide monomers, and polycaprolactone that can be broken down by bacteria. Other biodegradable polymers that can be used include lactic/glycolic acid copolymers (Coombes et al., U.S. Pat. No. 5,290,494; DeLuca et al., U.S. Pat. No. 5,160,745).

Other examples of fibers contemplated by the invention include ionically crosslinkable and hydrophilic polymers, covalently crosslinkable polymers, photo crosslinkable polymers and the like. As used herein, “hydrophilic polymers” are defined as polymers with a solubility of at least ten grams/liter of an aqueous solution at a temperature of between about 0 and 50° C. Aqueous solutions can include small amounts of water-soluble organic solvents, such as dimethylsulfoxide, dimethylformamide, alcohols, and/or acetone..

Suitable hydrophilic polymers include synthetic polymers such as poly(ethylene glycol), poly(ethylene oxide), partially or fully hydrolyzed poly(vinyl alcohol), poly(vinylpyrrolidone), poly(ethyloxazoline), poly(ethylene oxide)-co-poly(propylene oxide) block copolymers (poloxamers and meroxapols), polyoxamines, carboxymethyl cellulose, and hydroxyalkylated celluloses such as hydroxyethyl cellulose and hydroxypropyl methylcellulose, and natural polymers such as polypeptides, polysaccharides or carbohydrates such as Ficoll™, polysucrose, hyaluronic acid, graphite, dextran, heparin sulfate, chondroitin sulfate, heparin, or alginate, and proteins such as gelatin, collagen, albumin, or ovalbumin or copolymers or blends thereof. As used herein, “celluloses” includes cellulose and derivatives of the types described above; “dextran” includes dextran and similar derivatives thereof.

Examples of materials that can be used to form a hydrogel include modified alginates. Alginate is a carbohydrate polymer isolated from seaweed, which can be crosslinked to form a hydrogel by exposure to a divalent cation such as calcium, as described, for example in WO 94/25080, the disclosure of which is incorporated herein by reference. Alginate is ionically crosslinked in the presence of divalent cations, in water, at room temperature, to form a hydrogel matrix. Modified alginate derivatives may be synthesized that have an improved ability to form hydrogels. The use of alginate as the starting material is advantageous because it is available from more than one source, and is available in good purity and characterization. As used herein, the term “modified alginates” refers to chemically modified alginates with modified hydrogel properties. Naturally occurring alginate may be chemically modified to produce alginate polymer derivatives that degrade more quickly. For example, alginate may be chemically cleaved to produce smaller blocks of gellable oligosaccharide blocks and a linear copolymer may be formed with another preselected moiety, e.g. lactic acid or ε-caprolactone. The resulting polymer includes alginate blocks that permit ionically catalyzed gelling, and oligoester blocks that produce more rapid degradation depending on the synthetic design. Alternatively, alginate polymers may be used wherein the ratio of mannuronic acid to glucuronic acid does not produce a film gel, which are derivatized with hydrophobic, water-labile chains, e.g., oligomers of ε-caprolactone.

Additionally, polysaccharides that gel by exposure to monovalent cations, including bacterial polysaccharides, such as gellan gum, and plant polysaccharides, such as carrageenans, may be crosslinked to form a hydrogel using methods analogous to those available for the crosslinking of alginates described above. Polysaccharides that gel in the presence of monovalent cations form hydrogels upon exposure, for example, to a solution comprising physiological levels of sodium. Hydrogel precursor solutions also may be osmotically adjusted with an ionic species, such as mannitol, and then extruded to form a gel.

Polysaccharides that are very viscous liquids or are thixotropic, and form a gel over time by the slow evolution of structure, are also useful. For example, hyaluronic acid, which forms an extrudable gel with a consistency like a hair gel, may be utilized. Modified hyaluronic acid derivatives are particularly useful. As used herein, the term “hyaluronic acids” refers to natural and chemically modified hyaluronic acids. Modified hyaluronic acids may be designed and synthesized with preselected chemical modifications to adjust the rate and degree of crosslinking and biodegradation. For example, modified hyaluronic acids may be designed and synthesized that are esterified with a relatively hydrophobic group such as proprionic acid or benzylic acid to render the polymer more hydrophobic and gel-forming, or that are grafted with amines to promote electrostatic self-assembly. Modified hyaluronic acids thus may be synthesized that are extrudable, in that they flow under stress, but maintain a gel-like structure when not under stress. Hyaluronic acid and hyaluronic derivatives are available from Genzyme, Cambridge, Mass. and Fidia, Italy.

Other polymeric hydrogel precursors include polyethylene oxide-polypropylene glycol block copolymers such as Pluronics™ or Tetronics™, which are crosslinked by hydrogen bonding and/or by a temperature change. Other materials that may be utilized include proteins such as fibrin, collagen and gelatin. Polymer mixtures also may be utilized. For example, a mixture of polyethylene oxide and polyacrylic acid that gels by hydrogen bonding upon mixing may be utilized. A mixture of a 5% w/w solution of polyacrylic acid with a 5% w/w polyethylene oxide (polyethylene glycol, polyoxyethylene) 100,000 can be combined to form a gel over the course of time, e.g., as quickly as within a few seconds.

Water-soluble polymers with charged side groups may be crosslinked by reacting the polymer with an aqueous solution containing ions of the opposite charge, either cations if the polymer has acidic side groups or anions if the polymer has basic side groups. Examples of cations for cross-linking of the polymers with acidic side groups to form a hydrogel are monovalent cations such as sodium, divalent cations such as calcium, and multivalent cations such as copper, calcium, aluminum, magnesium, strontium, barium, and tin, and di-, tri- or tetra-functional organic cations such as alkylammonium salts. Aqueous solutions of the salts of these cations are added to the polymers to form soft, highly swollen hydrogels and membranes. The higher the concentration of cation, or the higher the valence, the greater the degree of cross-linking of the polymer. Additionally, the polymers may be crosslinked enzymatically, e.g., fibrin with thrombin.

Suitable ionically crosslinkable groups include phenols, amines, imines, amides, carboxylic acids, sulfonic acids and phosphate groups. Aliphatic hydroxy groups are not considered to be reactive groups for the chemistry disclosed herein. Negatively charged groups, such as carboxylate, sulfonate and phosphate ions, can be crosslinked with cations such as calcium ions. The crosslinking of alginate with calcium ions is an example of this type of ionic crosslinking. Positively charged groups, such as ammonium ions, can be crosslinked with negatively charged ions such as carboxylate, sulfonate and phosphate ions. Preferably, the negatively charged ions contain more than one carboxylate, sulfonate or phosphate group.

In the embodiment wherein modified alginates and other anionic polymers that can form hydrogels that are malleable are used to encapsulate cells, the hydrogel is produced by cross-linking the polymer with the appropriate cation, and the strength of the hydrogel bonding increases with either increasing concentrations of cations or of polymer. Cation concentrations as low as 0.001 M have been shown to cross-link alginate. Higher concentrations are limited by the toxicity of the salt.

Preferred anions for cross-linking of the polymers to form a hydrogel are monovalent, divalent or trivalent anions such as low molecular weight dicarboxylic acids, for example, terepthalic acid, sulfate ions and carbonate ions. Aqueous solutions of the salts of these anions are added to the polymers to form soft, highly swollen hydrogels and membranes, as described with respect to cations.

A variety of polycations can be used to complex and thereby stabilize the polymer hydrogel into a semi-permeable surface membrane. Examples of materials that can be used include polymers having basic reactive groups such as amine or imine groups, having a preferred molecular weight between 3,000 and 100,000, such as polyethylenimine and polylysine. These are commercially available. One polycation is poly(L-lysine); examples of synthetic polyamines are: polyethyleneimine, poly(vinylamine), and poly(allyl amine). There are also natural polycations such as the polysaccharide, chitosan.

Polyanions that can be used to form a semi-permeable membrane by reaction with basic surface groups on the polymer hydrogel include polymers and copolymers of acrylic acid, methacrylic acid, and other derivatives of acrylic acid, polymers with pendant SO₃H groups such as sulfonated polystyrene, and polystyrene with carboxylic acid groups. These polymers can be modified to contain active groups that are polymerizable and/or ionically crosslinkable groups. Methods for modifying hydrophilic polymers to include these groups are well known to those of skill in the art.

The polymers are preferably of low biodegradability so that they do not readily undergo dissolution and degradation but are also preferably of sufficiently low molecular weight to allow extrusion for easy application, for example, by spraying. The polymers can be a single block with a molecular weight of at least 600, preferably 2000 or more, and more preferably at least 3000. Alternatively, the polymers can include can be two or more water-soluble blocks that are joined by other groups. Such joining groups can include biodegradable linkages, polymerizable linkages, or both. For example, an unsaturated dicarboxylic acid, such as maleic, fumaric, or aconitic acid, can be esterified with hydrophilic polymers containing hydroxy groups, such as polyethylene glycols, or amidated with hydrophilic polymers containing amine groups, such as poloxamines.

Covalently crosslinkable hydrogel precursors also are useful. For example, a water-soluble polyamine, such as chitosan, can be cross-linked with a water-soluble diisothiocyanate, such as polyethylene glycol diisothiocyanate. The isothiocyanates will react with the amines to form a chemically crosslinked gel. Aldehyde reactions with amines, e.g., with polyethylene glycol dialdehyde also may be utilized. A hydroxylated water-soluble polymer also may be utilized.

Alternatively, polymers may be utilized that include substituents that are crosslinked by a radical reaction upon contact with a radical initiator. For example, polymers including ethylenically unsaturated groups that can be photochemically crosslinked may be utilized, as disclosed in WO 93/17669, the disclosure of which is incorporated herein by reference. In this embodiment, water-soluble macromers that include at least one water-soluble region, a biodegradable region, and at least two free radical-polymerizable regions, are provided. The macromers are polymerized by exposure of the polymerizable regions to free radicals generated, for example, by photosensitive chemicals and or light. Examples of these macromers are PEG-oligolactyl-acrylates, wherein the acrylate groups are polymerized using radical initiating systems, such as an eosin dye, or by brief exposure to ultraviolet or visible light. Additionally, water-soluble polymers that include cinnamoyl groups that may be photochemically crosslinked may be utilized, as disclosed in Matsuda et al., ASAID Trans., 38:154-157 (1992).

The term “active species polymerizable group” is defined as a reactive functional group that has the capacity to form additional covalent bonds resulting in polymer interlinking upon exposure to active species. Active species include free radicals, cations, and anions. Suitable free radical polymerizable groups include ethylenically unsaturated groups (i.e., vinyl groups) such as vinyl ethers, allyl groups, unsaturated monocarboxylic acids, unsaturated dicarboxylic acids, and unsaturated tricarboxylic acids. Unsaturated monocarboxylic acids include acrylic acid, methacrylic acid and crotonic acid. Unsaturated dicarboxylic acids include maleic, fumaric, itaconic, mesaconic or citraconic acid. In one embodiment, the active species polymerizable groups are preferably located at one or more ends of the hydrophilic polymer. In another embodiment, the active species polymerizable groups are located within a block copolymer with one or more hydrophilic polymers forming the individual blocks. The preferred polymerizable groups are acrylates, diacrylates, oligoacrylates, dimethacrylates, oligomethacrylates, and other biologically acceptable photopolymerizable groups. Acrylates are the most preferred active species polymerizable group.

In general, the polymers are at least partially soluble in aqueous solutions, such as water, salt solutions, or aqueous alcohol solutions. Methods for the synthesis of the other polymers described above are known to those skilled in the art. See, for example Concise Encyclopedia of Polymer Science and Polymeric Amines and Ammonium Salts, E. Goethals, editor (Pergamen Press, Elmsford, N.Y. 1980). Many polymers, such as poly(acrylic acid), are commercially available. Naturally occurring and synthetic polymers may be modified using chemical reactions available in the art and described, for example, in March, “Advanced Organic Chemistry,” 4th Edition, 1992, Wiley-Interscience Publication, New York.

Preferably, the hydrophilic polymers that include active species or crosslinkable groups include at least 1.02 polymerizable or crosslinkable groups on average, and, more preferably, each includes two or more polymerizable or crosslinkable groups on average. Because each polymerizable group will polymerize into a chain, crosslinked hydrogels can be produced using only slightly more than one reactive group per polymer (i.e., about 1.02 polymerizable groups on average). However, higher percentages are preferable, and excellent gels can be obtained in polymer mixtures in that most or all of the molecules have two or more reactive double bonds. Poloxamines, an example of a hydrophilic polymer, have four arms and thus may readily be modified to include four polymerizable groups.

Polymerization can also be initiated using photoinitiators. Photoinitiators that generate an active species on exposure to UV light are well known to those of skill in the art. Active species can also be formed in a relatively mild manner from photon absorption of certain dyes and chemical compounds.

These groups can be polymerized using photoinitiators that generate active species upon exposure to UV light, or, preferably, using long-wavelength ultraviolet light (LWUV) or visible light. LWUV and visible light are preferred because they cause less damage to tissue and other biological materials than UV light. Useful photoinitiators are those that can be used to initiate polymerization of the macromers without cytotoxicity and within a short time frame, minutes at most and most preferably seconds.

Exposure of dyes and cocatalysts such as amines to visible or LWUV light can generate active species. Light absorption by the dye causes the dye to assume a triplet state, and the triplet state subsequently reacts with the amine to form an active species that initiates polymerization. Polymerization can be initiated by irradiation with light at a wavelength of between about 200-700 nm, most preferably in the long wavelength ultraviolet range or visible range, 320 nm or higher, and most preferably between about 365 and 514 nm.

Numerous dyes can be used for photopolymerization. Suitable dyes are well known to those of skill in the art. Preferred dyes include erythrosin, phloxime, rose bengal, thionine, camphorquinone, ethyl eosin, eosin, methylene blue, riboflavin, 2,2-dimethyl-2-phenylacetophenone, 2-methoxy-2-phenylacetophenone, 2,2-dimethoxy-2-phenyl acetophenone, other acetophenone derivatives, and camphorquinone. Suitable cocatalysts include amines such as N-methyl diethanolamine, N,N-dimethyl benzylamine, triethanolamine, triethylamine, dibenzylamine, N-benzylethanolamine, N-isopropyl benzylamine. Triethanolamine is a preferred cocatalyst.

Photopolymerization of these polymer solutions occurs upon exposure to light equivalent to between one and 3 m Watts/cm². In general, combinations of polymers and photoinitiators will crosslink when a photoinitiator is present at a concentration at about 0.1% by weight, more preferably at about 0.01 or 0.05% by weight.

Examples of specific types of fibers that have been tested and that can be used include the following:

(1) 900 denier Spectra polyethylene fibers (e.g. 20 micron diameter fiber, 120-150 monofilaments per strand, Allied Corporation, New York, N.Y.);

2) small diameter graphite fibers (e.g. 6-7 micron diameter, 3000 monofilaments per strand);

3) 840 denier polyester fibers in six colors (white, red, blue, green, yellow and burgundy), 70 monofilaments per strand (Allied Corporation, New York, N.Y.);

4) constituent filaments of jute twine,

5) 1280 denier, black Unitaka polyester fibers (Unitaka), and

6) melt extruded ethylene vinyl acetate.

Fiber treatments can be placed as needed on the whole or parts of plants animals and structures. For example, fibers can be placed around the base of seedlings (e.g., for Acalymma, Diabrotica, Delia, and Leptinotarsa), as a covering over the entire seedling (e.g., for Epitrix, Plutella, Pieris, and Bemesia) or teased over the silks of sweet corn (e.g., Helicoverpa). Other fibers can be electrostatically-spun, and applied directly to form a “web” of fibers around the plant, animal, structure or part thereof. Other fibers that would be of use would include biological compounds or protein polymers.

Behavior modifying agents and deterrents can be incorporated into the fibers of the invention, for example, by linkage from one or more functional groups on the agent or deterrent to an ester, thioester, carboxyl or amide of a polymer. The functional groups on the behavior modifying agents and deterrents can, for example, be hydroxy groups (—OH), a mercapto groups (—SH), amine groups (—NHR), phosphate groups (—PO₄) or carboxylic acid groups (—COOH). The behavior modifying agents or deterrents can also comprise other functional groups that are not necessarily employed in linkage to the polymer. Such additional functional groups can be used or be involved in branching, cross-linking, appending other molecules to the polymer, changing the solubility of the polymer, or affecting the breakdown or biodegradation of the polymer. Hence, behavior modifying agents and deterrents can be covalently attached to fiber polymers through ester linkages, thioester linkages, amide linkages, thioamide linkages, anhydride linkages or a mixture thereof. Such ester, thioester, amide, thioamide, anhydride and/or linkages within the fibers of the invention can, under some environmental conditions (sunlight, moisture), undergo biodegradation of the fiber and release of the behavior modifying agent or deterrent.

In some embodiments, when a carboxylic acid is reacted with a hydroxy group, a mercapto group, or an amine group to provide an ester linkage, thioester linkage, or an amide linkage, the carboxylic acid can be activated prior to the reaction, for example, by formation of the corresponding acid chloride. Numerous methods for activating carboxylic acids, and for preparing ester linkages, thioester linkages, and amide linkages, are known in the art (see for example Advanced Organic Chemistry: Reaction Mechanisms and Structure, 4 ed., Jerry March, John Wiley & Sons, pages 419-437 and 1281).

As will be clear to one skilled in the art, suitable protecting groups can be used during linkage of a behavior modifying group or deterrent to a fiber polymer. For example, other functional groups present in the fiber, or on the behavior-modifying group or deterrent can be protected during linkage or polymerization, and the protecting groups can subsequently be removed to provide the fiber deterrent of the invention. Suitable protecting groups and methods for their incorporation and removal are well known in the art (see for example Greene, T. W.; Wutz, P. G. M. “Protecting Groups In Organic Synthesis” second edition, 1991, New York, John Wiley & sons, Inc.).

Pest Behavior Modifying Compounds and Pest Deterrents

Any pest deterrent or pesticide known to one of skill in the art can be adsorbed or attached onto the fibers of the present invention. For example, the deterrent or pesticide can be an acaricide, algicide, antifeedant, avicide, bactericide, bird repellent, chemosterilant, fungicide, herbicide safeners, herbicide, insect attractant, insect repellent, insecticide, mammal repellent, mating disrupter, molluscicide, nematicide, plant activator, plant growth regulator, rodenticide, synergist, virucide, or other chemical pesticide or deterrent. An acaricide is a pesticide used to destroy mites on domestic animals, crops, and humans; it is also known as a miticide. An avicide can be a compound such as 4-aminopyridine, chloralose, endrin, fenthion or strychnine. A virucide can be used to inhibit virus growth or to kill viruses. Imanin and ribavirin are examples of virucides. These types of deterrents and pesticides are further described at the website at hclrss.demon.co.uk/class_pesticides.html.

Such deterrents can include plant and insect semiochemicals such as pheromones, kairomones, and allomones that would influence insect behavior, for instance, by disrupting mating. Also contemplated are various aromas that repel pests, for example, hydrogen sulfide odor or hot pepper to deter deer. Herbicides are also contemplated such as allelotoxins (botanical herbicides). Sticky materials are also contemplated for inclusion into or onto the fibers of the present invention. Fungicides and algaecides can also be incorporated or adsorbed onto the fibers of the present invention. Fibers may constitute another way to deliver these fungicides and algaecides so that they are optimally placed on or around the plant.

In another embodiment, the present invention provides fibers with the proper characteristics for pest repellence and timed degradation so that the fibers and pest repellants remain intact only as long as necessary for efficacy. The fiber barrier would protect plants from pests yet degrade into inert ingredients prior to harvest.

Insecticides known to one of skill in the art are also contemplated for inclusion into or adsorption onto the fibers of the present invention. In one embodiment, such insecticide-fibers constitute an alternative method for delivering the material in a localized and optimal placed manner.

Pesticides that can be used in the fibrous deterrents of the invention include, for example, Bifonazole (antifungal), Binapacryl (fungicide, miticide), Bis(p-chlorophenoxy) methane (miticide), Bisphenol A (fungicide), Bitertanol (agricultural fungicide), Bromacil (herbicide), Bromadiolone (rodenticide), Bromethalinlin (rodenticide), Bromophos (insecticide), Bromopropylate (acaricide), Bupirimate (fungicide), Busulfan (insect sterilant), Butrylin (insecticide), Cambendazole (anthelminthic), Candicidin (topical antifungal), Candidin (topical antifungal), Captan (fungicide; bacteriostat), Carbaryl (contact insecticide), Carbendazim (fungicide), Carbophenothion (miticide; insecticide), Chloramben (herbicide), Chloramphenacol (palmitate antimicrobial), Chloranil (fungicide), Chlorbetamide (antiamebic), Chlordimeform (insecticide), Chlorfenac (herbicide), Chlorphenesin (topical antifungal), Chlorpyrifos (insecticide), Chlorsulfuron (herbicide), or Chlorothion (insecticide).

Other types of pesticides that can be used in the fibrous deterrents of the invention include antibiotic insecticides such as abamectin, allosamidin, doramectin, emamectin, eprinomectin, ivermectin, milbemectin, selamectin, spinosad, or thuringiensin; arsenical insecticides such as calcium arsenate, copper acetoarsenite, copper arsenate, lead arsenate, potassium arsenite, or sodium arsenite; botanical insecticides such as anabasine, azadirachtin, d-limonene, nicotine, pyrethrins, cinerin I, cinerin II, jasmolin I, jasmolin II, pyrethrin I, pyrethrin II, quassia, rotenone, ryania, or sabadilla; carbamate insecticides such as bendiocarb or carbaryl; benzofuranyl methylcarbamate insecticides such as benfuracarb, carbofuran, carbosulfan, decarbofuran or furathiocarb; dimethylcarbamate insecticides such as dimetan, dimetilan, hyquincarb or pirimicarb; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb or thiofanox; phenyl methylcarbamate insecticides such as allyxycarb, aminocarb, bufencarb, butacarb, carbanolate, cloethocarb, dicresyl, dioxacarb, ethiofencarb, fenethacarb, fenobucarb, isoprocarb, methiocarb, metolcarb, mexacarbate, promacyl, promecarb, propoxur, trimethacarb or xylylcarb; dinitrophenol insecticides such as dinex, dinoprop or dinosam; fluorine insecticides such as barium hexafluorosilicate, cryolite, sodium fluoride, sodium hexafluorosilicate or sulfluramid; formamidine insecticides such as amitraz, chlordimeform, formetanate or formparanate; fumigant insecticides such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, methyl bromide, methylchloroform, methylene chloride, naphthalene, phosphine, sulfuryl fluoride, or tetrachloroethane; inorganic insecticides such as borax, calcium polysulfide, mercurous chloride, potassium thiocyanate, or sodium thiocyanate; insect growth regulators including chitin synthesis inhibitors such as bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron or triflumuron; juvenile hormone mimics such as epofenonane, fenoxycarb, hydroprene, kinoprene, methoprene, pyriproxyfen or triprene; juvenile hormones such as juvenile hormone I, juvenile hormone II, or juvenile hormone III; moulting hormone agonists such as chromafenozide, halofenozide, methoxyfenozide or tebufenozide; moulting hormones such as α-ecdysone or ecdysterone; moulting inhibitors such as diofenolan; precocenes such as precocene I, precocene II, or precocene III; unclassified insect growth regulators such as dicyclanil; nereistoxin analogue insecticides such as bensultap, cartap, thiocyclam, or thiosultap; nicotinoid insecticides such as flonicamid; nitroguanidine insecticides such as clothianidin, dinotefuran or thiamethoxam; nitromethylene insecticides such as nitenpyram or nithiazine; pyridylmethylamine insecticides such as acetamiprid, imidacloprid, nitenpyram or thiacloprid; organochlorine insecticides such as bromo-DDT, camphechlor, DDT, pp′-DDT, methoxychlor, or pentachlorophenol; cyclodiene insecticides such as aldrin, chlorbicyclen, chlordane, chlordecone, dieldrin, dilor, endosulfan, endrin, heptachlor, isobenzan, isodrin, kelevan, or mirex; organophosphorus or organo phosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, schradan, or tetrachlorvinphos; organothiophosphate insecticides such as dioxabenzofos, fosmethilan, or phenthoate; aliphatic organothiophosphate insecticides such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, isothioate, malathion, methacrifos, oxydemeton-methyl, oxydeprofos, oxydisulfoton, phorate, sulfotep, terbufos or thiometon; aliphatic amide organothiophosphate insecticides such as amidithion, cyanthoate, dimethoate, ethoate-methyl, formothion, mecarbam, omethoate, prothoate, sophamide, or vamidothion; oxime organothiophosphate insecticides such as chlorphoxim, phoxim, or phoxim-methyl; heterocyclic organothiophosphate insecticides such as azamethiphos, coumaphos, coumithoate, dioxathion, endothion, menazon, morphothion, phosalone, pyraclofos, pyridaphenthion or quinothion; benzothiopyran organothiophosphate insecticides such as dithicrofos or thicrofos; benzotriazine organothiophosphate insecticides such as azinphos-ethyl or azinphos-methyl; isoindole organothiophosphate insecticides such as dialifos or phosmet; isoxazole organothiophosphate insecticides such as isoxathion or zolaprofos; pyrazolopyrimidine organothiophosphate insecticides such as chlorprazophos or pyrazophos; pyridine organothiophosphate insecticides such as chlorpyrifos or chlorpyrifos-methyl; pyrimidine organothiophosphate insecticides such as butathiofos, diazinon, etrimfos, lirimfos, pirimiphos-ethyl, pirimiphos-methyl, primidophos, pyrimitate or tebupirimfos; quinoxaline organothiophosphate insecticides such as quinalphos or quinalphos-methyl; thiadiazole organothiophosphate insecticides such as athidathion, lythidathion, methidathion or prothidathion; triazole organothiophosphate insecticides such as isazofos or triazophos; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3 or trifenofos; phosphonate insecticides such as butonate or trichlorfon; phosphonothioate insecticides such as mecarphon; phenyl ethylphosphonothioate insecticides such as fonofos or trichloronat; phenyl phenylphosphonothioate insecticides such as cyanofenphos or leptophos; phosphoramidate insecticides such as crufomate, fenamiphos, fosthietan, mephosfolan, phosfolan or pirimetaphos; phosphoramidothioate insecticides such as acephate, isofenphos, methamidophos or propetamphos; phosphorodiamide insecticides such as dimefox, mazidox or mipafox; oxadiazine insecticides such as indoxacarb; pyrazole insecticides such as acetoprole, ethiprole, fipronil, tebufenpyrad, tolfenpyrad or vaniliprole; pyrethroid insecticides including pyrethroid ester insecticides such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin or transfluthrin; pyrethroid ether insecticides such as etofenprox, flufenprox, halfenprox, protrifenbute or silafluofen; pyrimidinamine insecticides such as flufenerim or pyrimidifen; tetronic acid insecticides such as spiromesifen; or other unclassified insecticides such as chlorfenapyr, closantel, crotamiton, diafenthiuron, fenazaflor, fenoxacrim, flucofuron, hydramethylnon, isoprothiolane, malonoben, metoxadiazone, nifluridide, pyridaben, pyridalyl, rafoxanide, sulcofuron, triarathene or triazamate. These types of compounds are further described at the website at hclrss.demon.co.uk/class_pesticides.html.

Moreover, Bacillus thuringiensis (or “Bt”) bacteria include nearly twenty known subspecies of bacteria that produce endotoxin polypeptides that are toxic when ingested by a wide variety of insect species. The biology and molecular biology of the endotoxin proteins (Bt proteins) and corresponding genes (Bt genes) has been reviewed by H. R. Whitely et al., Ann. Rev. Microbiol., 40, 549 (1986) and by H. Hofte et al., Microbiol. Rev., 53, 242 (1989). Genes coding for a variety of Bt proteins have been cloned and sequenced. A segment of the Bt polypeptide is essential for toxicity to a variety of Lepidoptera and other arthropod pests and is contained within approximately the first 50% of the Bt polypeptide molecule. Consequently, a truncated Bt polypeptide coded by a truncated Bt gene will in many cases retain its toxicity towards a number of Lepidoptera insect pests. For example, the HD73 and HD1 Bt polypeptides have been shown to be toxic to the larvae of the important Lepidoptera insect pests of plants in the USA such as the European corn borer, cutworms and earworms. Such polypeptides can be incorporated into the fibrous deterrents of the invention.

In some embodiments, the fibers of the invention can include insect repellents. Examples of such insect repellents include butopyronoxyl, dibutyl phthalate, diethyltoluamide, dimethyl carbate, dimethyl phthalate, ethohexadiol, hexamide, methoquin-butyl, methylneodecanamide, oxamate, or picaridin. In other embodiments, the fibers of the invention can include insect attractants. Examples of such insect attractants include, brevicomin, codlelure, cue-lure, disparlure, dominicalure, eugenol, frontalin, gossyplure, grandlure, hexalure, ipsdienol, ipsenol, japonilure, lineatin, litlure, looplure, medlure, megatomoic acid, methyl eugenol, α-multistriatin, muscalure, orfralure, oryctalure, ostramone, siglure, sulcatol, trimedlure or trunc-call. These types of compounds are further described at the website at hclrss.demon.co.uklclass_pesticides.html.

The fibers of the invention can include chemosterilants that can inhibit or reduce reproduction by a variety of invertebrate pests. For example, the fibers of the invention can include chemosterilants such as apholate, bisazir, busulfan, diflubenzuron, dimatif, hemel, hempa, metepa, methiotepa, methyl apholate, morzid, penfluron, tepa, thiohempa, thiotepa, tretamine or uredepa. Similarly, mating disrupters such as disparlure, gossyplure or grandlure can be used with the fibers of the invention. These types of compounds are further described at the website at hclrss.demon.co.uk/class_pesticides.html.

Incorporation of olfactory repellents is another aspect of the invention that enhances the effectiveness of fiber barriers. Compounds contemplated include those capable of suppressing D. antiqua oviposition such as phenolics and monoterpenoids (Cowles and Miller 1992), and pungent spices such as dill, paprika, black pepper, chili powder, ginger, caffeine, or red pepper (Cowles et al. 1989). In addition, the present invention contemplates including capsaicin into the present fibrous deterrents. Capsaicin can be used to deter mammals and other pests, including insects and molluscs. For example, capsaicin deters D. antiqua oviposition (Cowles et al. 1989). Addition of capsaicin oleoresin to EVA fibers is an effective treatment that significantly reduced maggot numbers compared with non-treated broccoli plants.

The present invention also is directed to visual enhancements within fibers. Researchers have shown that color and shape are important cues for Delia spp. to find host plants (Harris and Miller 1983; Prokopy et al. 1983; Tuttle et al. 1988) and reflectance of visible and ultraviolet light can act as a repellent to numerous insect species, including D. radicum. The fibers can be colored or dyed to provide camouflage so that the fibers blend into the plant, animal or structure to which they will be applied. Such colored fibers can be used to disguise a structure, hide a bald spot in a lawn or other area, or fill an opening in a foundation or in the siding of a building. Accordingly, the present invention also provides fibers with dyes, color enhancers and brighteners.

The fiber deterrents of the invention can also deter nematodes. Such fiber deterrents can include nematicides that are covalently attached or stably adsorbed to the fibers. Examples of nematicides that can be used include antibiotic nematicides such as abamectin; carbamate nematicides such as benomyl, carbofuran, carbosulfan, or cloethocarb; oxime carbamate nematicides such as alanycarb, aldicarb, aldoxycarb, or oxamyl; organophosphorus or organophosphate nematicides such as diamidafos, fenamiphos, fosthietan, or phosphamidon; organothiophosphate nematicides such as cadusafos, chlorpyrifos, dichlofenthion, dimethoate, ethoprophos, fensulfothion, fosthiazate, heterophos, isamidofos, isazofos, mecarphon, phorate, phosphocarb, terbufos, thionazin, or triazophos; or other nematicides such as acetoprole, benclothiaz, chloropicrin, dazomet, 1,2-dibromo-3-chloropropane, bis(2-chloro-1-methylethyl) ether, 1,2-dichloropropane, 1,3-dichloropropene, metam, methyl bromide, methyl isothiocyanate or xylenol compounds. These types of compounds are further described at the website at hclrss.demon.co.uk/class_pesticides.html.

Molluscs can be repelled by the fiber deterrents of the invention. Mollusc repellents can be used in conjunction with such fiber deterrents, for example, bromoacetamide, caffeine, calcium arsenate, cloethocarb, copper acetoarsenite, copper sulfate, fentin, metaldehyde, methiocarb, niclosamide, pentachlorophenol, sodium pentachlorophenoxide, tazimcarb, thiodicarb, tributyltin oxide, trifenmorph, trimethacarb or elemental copper. These types of compounds are further described at the website at hclrss.demon.co.uk/class_pesticides.html.

The fibers of the invention can also include an antifeedant, for example, chlordimeform, fentin, guazatine or pymetrozine. These types of compounds are further described at the website at hclrss.demon.co.uk/class_pesticides.

Bird repellents can also be utilized with the fibers of the invention, for example, anthraquinone, chloralose, copper oxychloride, diazinon, guazatine, methiocarb, trimethacarb or ziram. See the website at hclrss.demon.co.uk/class_pesticides.html. Complex sugars can be adsorbed or attached to fibers to act as repellents for birds. For example, a spun sucrose “cotton candy” can be applied to plants. Use of the present fibrous deterrents in this manner, for example, will protect sweet corn, seed corn, cherries, blueberries, strawberries, nurseries and tree seedlings.

Rodents, squirrels, groundhogs, rabbits, deer, elk and other vertebrates can be deterred from injuring or consuming plants and structures by the present fibrous deterrents. For example, the fibers alone can protect plants from foraging by herbivores such as deer, elks, rabbits, groundhogs, rodents and squirrels. Repellents that can be used in conjunction with the fibrous barriers of the invention include, for example, copper naphthenate, trimethacarb, zinc naphthenate, or ziram. See the website at hclrss.demon.co.uk/class_pesticides. Moreover, fibers can also comprise a behavior-modifying substance such as capsaicin, hydrogen sulfide and other substances to further repel such vertebrates from crops and other plants. Combining fibers with fine sand particles creates a physical barrier to gnawing vertebrates such as rodents that can protect wooden structures and plants such as trees.

Rodents such as mice or rats can also be deterred from consuming or injuring plants and structures by fibers that have rodenticides covalently attached or stably adsorbed to those fibers. Such rodenticides can be botanical rodenticides such as scilliroside or strychnine; coumarin rodenticides such as brodifacoum, bromadiolone, coumachlor, coumafuryl, coumatetralyl, difenacoum, difethialone, flocoumafen, or warfarin; indandione rodenticides such as chlorophacinone, diphacinone, or pindone; inorganic rodenticides such as arsenous oxide, phosphorus, potassium arsenite, sodium arsenite, thallium sulfate or zinc phosphide; organochlorine rodenticides such as gamma-HCH, HCH, or lindane; organophosphorus rodenticides such as phosacetim; or other rodenticides such as antu, bromethalin, chloralose, α-chlorohydrin, crimidine, ergocalciferol, fluoroacetamide, flupropadine, hydrogen cyanide, norbormide, pyrinuron, or sodium fluoroacetate. These types of compounds are further described at the website at hclrss.demon.co.uk/class_pesticides.

Other additives can also be incorporated into the present fibers. Antibacterial agents can be added to or incorporated into the present fibrous compositions. Fire suppression additives can be used. Spill absorbing materials can be incorporated or adsorbed onto the fibers so that other compounds and compositions can be stably adsorbed onto the fibers. Materials that facilitate fibers degradation can be employed to help the fibers and the deterrent(s) biodegrade as the need for the fiber and deterrent disappears (e.g. by harvest time). Materials that facilitate wound closure in plants can also be used, for example, “shrinking” fibers could be used after trimming or “plant surgery” on plants such as trees. The fibers can be combined with fertilizers, minerals and other useful agents to enrich the soil and prevent soil erosion. Fertilizers can be incorporated into the present fibrous compositions, for example, in a manner that permits sustained release of the fertilizer.

The deterrents, behavior-modifying compounds, pesticides and other ingredients can be sprayed onto the fibers of the invention or incorporated into the fibers, for example, during fiber generation. The deterrents, behavior-modifying compounds, pesticides and other ingredients can be stably absorbed, dried onto the fibers or covalently attached to the fibers. One of skill in the art can readily utilize various functional groups available on the fibers and the desired deterrent or other compound to generate such a covalent linkage.

The invention is further illustrated by the following examples, which are not intended to limit the invention in any manner.

### EXAMPLE 1

### Efficacy of Various Fiber Barriers to Reduce Feeding Damage to Plants Methods and Materials

These experiments were performed to determine the efficacy of fiber barriers in reducing feeding damage or oviposition (egg laying) by insect pests. In feeding damage and oviposition studies, many insects were initially tested in “choice” and “no choice” conditions with regard to their approach to specific types of fiber barriers. Insect pests were presented with a known food source for that species of insect, and data were developed with regard to the amount of feeding damage inflicted or the rate of oviposition on the offered plant in the laboratory, the greenhouse, and in field trials. Methodology of approach is presented, as well as results of tests of the susceptibility of various plants to insect damage with regard to the use of non-woven fiber barriers of various types, colors, and densities.

Laboratory insect cage studies were conducted to determine the effect of various fiber types and configurations (e.g., density per unit area, distance from plant tissue etc.) of obstructive barriers in preventing insects from laying eggs or feeding on specific vegetable crops. Several different crop types and pests were utilized. Once the optimal fiber barrier and its placement were determined for a specific pest and crop, that combination was tested under field conditions to determine efficacy in preventing insect oviposition and injury to the given agricultural crops.

Choice Versus No Choice Tests

In the experiments run, the insect pests were presented with food sources that they recognize and are known to eat or oviposition. “Choice Tests” or “No Choice Tests” were developed so that data regarding the effectiveness of fiber barriers could be obtained. No Choice Tests refer to the use of the various barriers on all the host plants available to the insect pest. That is, the insects were presented only untreated plants or only treated plants. Choice Tests refer to the availability of the normal plant host of the insect pest both with and without the placement of fiber barriers in the same environment or test conditions.

Squash—Acalymma and Diabrotica spp.

Laboratory Experiments

Striped and spotted cucumber beetles were held in polystyrene containers (18.4×13.3×10.2 cm) under a 16:8 light: dark cycle and 15-20° C. ambient temperature. Beetles were provided with fresh cut cucurbit foliage daily as a food source and harborage along with a water source in the form of a dental wick placed into a small, closed petri dish with water. Thirty minutes prior to testing, beetles were removed, and placed in 4 dram glass vials and allowed to acclimate to ambient test conditions. Laboratory behavioral experiments using both species of cucumber beetles were performed under a combination of fluorescent light, incandescent light and daylight at 22° C., under a 16:8 hr light:dark cycle. Laboratory arenas for Acalymma and Diabrotica were the same polystyrene boxes containing a single, squash seedling (with two cotyledons) planted in a greenhouse potting mixture. Control arenas housed plants, Waltham Winter squash-variety “Butternut” and summer squash-variety “Seneca”, without fibers, while fiber treatments were each applied to different plants in similar arenas. The arenas were covered with rectangular, 0.16 cm thick, clear Plexiglas to facilitate observations and minimize air current interference and/or fiber movement.

Individual beetles were transferred from vials to the potting soil surface and allowed to move freely about the test arena. The 20-minute observation period for behavioral recording could be extended if necessary (e.g., the beetle was in contact with the fiber barrier or in partial contact with the plant). The observation period was terminated when the beetle's body was in full contact with the plant (i.e., plant acquisition). While all beetles were observed until plant acquisition, or at least 20 minutes, only the behavior of those beetles, which attempted to reach the seedling, was included in the analyses. At the end of each observation period, beetles were individually placed in vials containing 95% ethanol and later sexed. Laboratory experiments were replicated at least 15 times for the control and each treatment using different Acalymma to minimize the effect of previous experience. Total observation time and the duration of individual behavioral events were recorded (seconds) along with data on certain behavioral parameters. The behavior of individual beetles when confronted by fiber barriers was characterized by four repeatable and quantifiable parameters that allowed us to assess fiber treatment efficacy for data analysis: total time, approach, time per approach and number of repels. These parameters are defined below.

Total time: Total time during the ≦20 minute observation period during which the insect was in contact with fiber barrier or within 2 cm radius of the stem of a control plant. Timing continued until the insect left the timing radius, broke off contact with the barrier or acquired the plant (i.e., attains full, unobstructed contact with the plant surface).

Approach: Insect, moving in a goal-oriented fashion, makes contact with fiber barrier or enters the 2-cm radius thereby initiating the timing of contact. Data from insects, which failed to “approach” the test plant, were not used in any analyses.

Time/Approach: Total time divided by the number of observed approaches. The insect, although having recorded one or more approaches, is never able to acquire the plant during the observation period.

Greenhouse Experiments

Two arena types were used in the greenhouse experiments. First, polyethylene, 2-liter soda containers that had been separated from their bases, had their mouths removed, had a square window cut and had both openings covered with fine mesh fabric. An access hole was cut for the introduction of test insects and sealed with foam plugs. A 3.81 cm dental wick, soaked in a 10% sucrose-water solution and inserted into the foam plug, was provided to the experimental insect in each arena. A single squash seedling was planted in greenhouse potting soil within the base and the clear section of the bottle was inverted and slid within the base to enclose the arena for Acalymma and Diabrotica experiments. Control plants received no treatment while experimental plants received a cover of a specified length/density of graphite or polyester multifilaments. For choice tests with multiple plants, including tests of fiber color effects, rectangular (30.48×60.96×30.48 cm) or square (45.72×45.72×45.72 cm) screen cages were arranged to house planting trays containing 4 or 5 seedlings in greenhouse potting soil. Greenhouse studies for all test species were performed under a combination of daylight and incandescent grow light and ambient temperatures ranging between 23.5 and 34° C. and a 16:8 hr light cycle.

Individual or groups of three to five cucumber beetles of undetermined sex were introduced into each polyethylene arena containing a treated or untreated seedling. The insects were allowed to move freely about each container for at least 24 hours but, in some trials, up to 72 hours, then removed. Beetles were then preserved in alcohol to be later sexed. To determine damage (the area of leaf material removed by beetles) in each replicate, each cotyledon was removed, traced on paper to its perceived pre-test area, and along with this tracing, measured with a calibrated LC3 leaf area meter (LiCor, Inc., Lincoln, Nebr.). The difference was recorded as leaf tissue loss. In addition, areas of each cotyledon that were scoured by beetle feeding, rather than fully removed, were removed by scalpel or insect pin and the leaf area re-measured to assess real tissue damage. At least ten replicates each of the control, low fiber treatment (3×5 cm length of fiber), medium fiber treatment (6×5 cm length of fiber) and high level (9×5 cm length of fiber) graphite for density, 3×5 cm lengths of graphite and polyethylene with PVA treated plants for fiber type or blue, red, green, yellow and white polyester for color trials were performed.

Field Experiments

Field choice tests, were performed without cages using cotyledon-age summer squash seedlings raised under greenhouse conditions that were transplanted directly within mature, pumpkin plots with pre-existing natural populations of beetles. Transplanted squash cotyledons were placed in rows with 1.21 m spacing between rows and plants within rows (control and either 3 or 4 treatments). Beetles were allowed to feed for 48 hours with behavior observed periodically. At the end of that time, beetles were removed from the seedlings and the feeding damage assessed visually and then the plants were returned to the laboratory, in soil to prevent desiccation, and the cotyledons measured with a calibrated leaf area meter. The start date for field trials was 9/5/96 for both density and color choice. Meteorological parameters including precipitation, wind velocity and temperature, collected within 500 meters of experimental cages, were monitored during all field trials.

### Potato—Leptinotarsa

Laboratory/Greenhouse Experiments

Seed potatoes, stored in a cooler and brought to 28° C. temperature for one week, were cut by hand and placed in six-packs with potting mix in a greenhouse and allowed to sprout seedlings. Laboratory and greenhouse protocols and arenas for Leptinotarsa were the same as those used for Acalymma and Diabrotica above, containing one (for behavioral experiments) or more (choice experiments) potato seedlings planted in an approximately flat-surfaced matrix of greenhouse potting mixture. Behavioral and leaf damage studies were performed under a combination of daylight and incandescent grow light and ambient temperatures ranging between 23.5 and 34° C. and a day length of 16:8 hr.

Field Experiments

At the start of a field trial, ten small cages (blocks) were each erected over 5 transplanted potato seedlings in two alternating rows with 30.5 cm spacing between both rows and plants within rows (control and 4 treatments). Beetles for field trials were transported from the laboratory in screened cages held in a cooler. Meteorological parameters including precipitation, wind velocity and temperature, collected within 500 meters of experimental cages, were monitored during all field trials. Ten adult Leptinotarsa were released into each cage and allowed to feed for 24 hours with behavior observed periodically. At the end of that time, beetles were removed and the feeding damage assessed visually and then the plants were returned to the laboratory, in soil to prevent desiccation, and the cotyledons measured with a calibrated leaf area meter as described above. Start dates for field trials were June 30 and July 3 for density choice and Jul. 11, 1996 for color choice.

### Radish—Epitrix

Greenhouse

The response of flea beetles to fiber barriers was tested with the treated and untreated radish variety “Champion.” The same arenas were used for flea beetle studies as for other beetle behavioral studies described above, with a 10:4 sand/top soil mixture as a planting matrix and light colored background so that the movement of the beetles could be observed. Twenty arenas, 5 of each treatment (untreated, polyethylene, graphite and PVA) were run simultaneously under identical ambient conditions. For Epitrix trials, individual beetles were not observed individually due to their small size and high mobility. Instead, acquisition by any of the beetles, was monitored and recorded every 10 minutes for the first hour and at two 30-minute time points in the second hour.

### EXAMPLE 2

### Results of Feeding Damage Trials

All the experiments related below were arranged in a complete randomized block design where appropriate and data analyzed using SuperAnova™ (Abacus Concepts, Inc. 1989). Where sub-samples were taken within the same cage, cage treatment means were analyzed. Means testing was performed with Fisher's LSD to discern differences between treatments. As appropriate, data were square root transformed and proportions arc/sine square root transformed prior to analyses.

### Squash—Acalymma and Diabrotica spp.

Under no choice conditions all spotted cucumber beetle behavioral parameters showed significant responses to fiber treatments. Significant differences were recorded between the mean total contact time for untreated and fiber treated winter squash plants (p=0.023; Table 1). Likewise, number of approaches (p=0.0004, range: control=1.00±0.00 versus high density 3.10±0.50), time in contact with fibers per approach (p=0.030), and the proportion of unsuccessful plant acquisitions or repels (p<0.001; Table 2) were significantly different. These parameters were not statistically different between each sex (p=0.588-1.000), determined a posteriori through dissection.

When spotted cucumber beetles were given a choice, no significant differences in leaf damage were observed between untreated squash and squash treated with 3×5 cm graphite or 3×5 cm polyethylene (p=0.212) in fiber type comparisons. Likewise, no particular polyester fiber color (red, blue, green, white, or yellow) significantly deterred feeding by spotted cucumber beetles (p=0.194). Mixed groups of beetles containing both sexes, determined a posteriori through dissection, caused significantly more proportional squash leaf damage (chew, p=0.042; chew+scour, p=0.005) than do same-sex groupings in fiber type choice experiments.

TABLE 1
The time in contact with fibers per insect approach
as a function of fiber density

| | | Standard |
|---|---|---|
| Density | Total time | error |
| Control | 2.65 | 0.37 |
| 1 × 5 cm | 67.90 | 24.91 |
| 2 × 5 cm | 99.20 | 47.16 |
| 3 × 5 cm | 68.60 | 15.59 |

TABLE 2
Unsuccessful plant acquisitions (repels)
with increasing fiber density

| | Proportion | Standard |
|---|---|---|
| Density | of Repels | error |
| Control | 0.00 | 0.00 |
| 1 × 5 cm | 0.20 | 0.13 |
| 2 × 5 cm | 0.90 | 0.10 |
| 3 × 5 cm | 0.90 | 0.10 |

Under no choice conditions fiber density had a significant influence on behavioral parameters such as time in contact with the fibers or time striped cucumber beetles were within 2 cm of stem (p<0.001; Table 3), approach (p<0.001; Table 4), time in contact with fibers/approach (p<0.001; Table 5) and the proportion of unsuccessful plant acquisitions (p<0.001; Table 6). Fiber type had a significant influence on parameters such as total time (seconds) in contact with the fibers or within 2 cm of stem (p=0.0001; Table 7), approach number (p<0.001; Table 8), time in contact with fibers/approach (p<0.001; Table 9), and the proportion of unsuccessful plant acquisitions (p<0.001; Table 10). The feeding damage data for laboratory density choice experiments suggests no significant deterrent to feeding attributable to fiber treatments (p=0.181). Field graphite density choice studies (untreated, 1×5, 3×5, 6×5 and 9×5 graphite tow) exhibit a significant reduction in mean leaf damage (p=0.012; Table 11) and proportional leaf damage (p=0.007; Table 12) with increasing density. This was inconsistent with some of the earlier laboratory results. Fiber type (untreated, 3×5 cm polyethylene, graphite and jute fibers) produced no significant differences in actual (p=0.357) or proportional (p=0.265) leaf damage between treatments. Because these field experiments are uncaged, damage may be due to not only to Acalymma but also to Diabrotica spp. (D. virgifera virgifera, D. barberi and D. undecimpunctata howardi), which also feed on squash and are active in the field simultaneously.

TABLE 3
The pests' time in contact with fibers
as a function of fiber density

| | Total time | Standard |
|---|---|---|
| Density | (sec) | error |
| Control | 1.50 | 0.22 |
| 1 × 1 cm | 18.07 | 3.98 |
| 2 × 1 cm | 63.93 | 24.56 |
| 3 × 1 cm | 64.07 | 10.84 |
| 5 × 1 cm | 109.31 | 20.73 |
| 1 × 5 cm | 138.25 | 26.37 |

TABLE 4
The ability of increasing fiber density
to increase the pests' approach
to plant patterns (no choice conditions)

| | Number of | Standard |
|---|---|---|
| Treatment | Approaches | error |
| Control | 1.00 | 0.00 |
| 1 × 1 | 1.50 | 0.13 |
| 2 × 1 | 1.79 | 0.19 |
| 3 × 1 | 2.34 | 0.23 |
| 5 × 1 | 3.56 | 0.47 |
| 1 × 5 | 3.18 | 0.32 |

TABLE 5
The influence of increasing fiber density
on time in contact
with fibers (no choice conditions)

| | Time/Approach | |
|---|---|---|
| Density | error | Standard |
| Control | 1.50 | 0.22 |
| 1 × 1 | 11.16 | 2.54 |
| 2 × 1 | 24.94 | 4.54 |
| 3 × 1 | 22.52 | 2.28 |
| 5 × 1 | 35.64 | 6.70 |
| 1 × 5 | 56.29 | 15.00 |

TABLE 6
Proportion of repels (no plant acquisition)
with increasing
fiber density (no choice conditions)

| | Proportion | Standard |
|---|---|---|
| Density | of repels | error |
| Control | 0.00 | 0.00 |
| 1 × 1 cm | 0.40 | 0.13 |
| 2 × 1 cm | 0.53 | 0.13 |
| 3 × 1 cm | 0.60 | 0.09 |
| 5 × 1 cm | 0.69 | 0.12 |
| 1 × 5 cm | 0.94 | 0.06 |

TABLE 7
Fiber type influence on
the time in contact with fibers

| | Total Contact | Standard |
|---|---|---|
| Density | Time (sec) | error |
| Control | 1.50 | 0.22 |
| Polyethylene | 32.25 | 4.72 |
| Graphite | 77.32 | 8.73 |

TABLE 8
Number of pest approaches
to the plant as a function of fiber type

| | Number of | Standard |
|---|---|---|
| Treatment | Approaches | error |
| Control | 1.00 | 0.00 |
| Polyethylene | 1.63 | 0.14 |
| Graphite | 2.73 | 0.16 |

TABLE 9
Total time in contact/approach with
the plant as a function of fiber type

| | Time/Approach | Standard |
|---|---|---|
| Treatment | (Seconds) | error |
| Control | 1.50 | 0.22 |
| Polyethylene | 19.58 | 2.26 |
| Graphite | 29.20 | 3.57 |

TABLE 10
Proportion of unsuccessful plant acquisitions
(repels) as a function of fiber type

| | Proportion | Standard |
|---|---|---|
| Treatment | repelled | error |
| Control | 0.00 | 0.00 |
| Polyethylene | 0.20 | 0.05 |
| Graphite | 0.63 | 0.05 |

TABLE 11
Increasing graphite fiber
density in the field reduces leaf damage

| | Mean leaf | Standard |
|---|---|---|
| Treatment | Damage (cm²) | error |
| Control | 12.21 | 4.16 |
| 1 × 5 | 10.46 | 3.24 |
| 3 × 5 | 3.99 | 0.66 |
| 6 × 5 | 2.97 | 0.58 |
| 9 × 5 | 2.54 | 0.30 |

TABLE 12
Increasing graphite fiber density in the field
reduces the proportion of leaf damage

| Treatment | Proportion leaf damage | Standard error |
|---|---|---|
| Control | 0.47 | 0.14 |
| 1 × 5 | 0.46 | 0.15 |
| 3 × 5 | 0.16 | 0.04 |
| 6 × 5 | 0.11 | 0.02 |
| 9 × 5 | 0.09 | 0.01 |

### Potato—Leptinotarsa

Under “No Choice” conditions fiber density had a significant influence on total time (seconds) Colorado potato beetles were in contact with the fibers or within 2 cm of stem (p<0.001; Table 13), number of approaches (p<0.001; Table 14), time in contact with fibers/approach (p<0.001; Table 15) and the proportion of unsuccessful plant acquisitions (p<0.001; Table 16). Fiber type also had a significant influence on total time (seconds) (p=0.007; Table 17), approach number (p=0.0207; Table 18), time in contact with fibers/approach (p=0.032; Table 19), and the proportion of unsuccessful plant acquisitions (p<0.001; Table 20).

TABLE 13
Under no choice conditions, fiber density influence
on a pest's total time in contact with the fiber barrier

| Treatment | Total time | Standard error |
|---|---|---|
| Control | 2.44 | 0.34 |
| 1 × 5 | 29.32 | 7.16 |
| 2 × 5 | 41.95 | 8.68 |
| 3 × 5 | 88.14 | 18.88 |
| P1 × 5 | 16.76 | 2.88 |
| P2 × 5 | 104.60 | 19.99 |
| P3 × 5 | 57.25 | 13.33 |
| PVA | 42.05 | 6.94 |

TABLE 14
Under no choice conditions, fiber density influence
on the number of pest approaches to the plant

| Density | Number of approaches | Standard error |
|---|---|---|
| Control | 1.00 | 0.00 |
| 1 × 5 | 1.79 | 0.30 |
| 2 × 5 | 1.52 | 0.18 |
| 3 × 5 | 1.91 | 0.32 |
| P1 × 5 | 1.20 | 0.13 |
| P2 × 5 | 2.50 | 0.52 |
| P3 × 5 | 2.60 | 0.47 |
| PVA | 1.25 | 0.12 |

TABLE 15
Under no choice conditions, fiber density marked
influence on time in had a contact/approach with fibers

| Density | Time/Approach | Standard error |
|---|---|---|
| Control | 2.44 | 0.34 |
| 1 × 5 | 19.68 | 6.25 |
| 2 × 5 | 28.71 | 5.67 |
| 3 × 5 | 54.88 | 14.63 |
| P1 × 5 | 14.18 | 2.43 |
| P2 × 5 | 53.00 | 16.10 |
| P3 × 5 | 24.73 | 5.75 |
| PVA | 35.37 | 6.08 |

TABLE 16
Under no choice conditions, fiber density influence
on the proportion of unsuccessful plant acquisitions (repels)

| Density | Proportion of Repels | Standard error |
|---|---|---|
| Control | 0.00 | 0.00 |
| 1 × 5 | 0.63 | 0.11 |
| 2 × 5 | 0.67 | 0.11 |
| 3 × 5 | 0.67 | 0.11 |
| P1 × 5 | 0.36 | 0.10 |
| P2 × 5 | 0.40 | 0.11 |
| P3 × 5 | 0.95 | 0.05 |
| PVA | 0.00 | 0.00 |

TABLE 17
Total time to the plant per insect as a function of fiber type

| Treatment | Total time (Seconds) | Standard error |
|---|---|---|
| Control | 2.44 | 0.34 |
| Polyethylene | 56.25 | 8.63 |
| Graphite | 53.92 | 8.05 |
| PVA | 42.05 | 6.94 |

TABLE 18
Number of approaches to the plant per insect
as a function of fiber type

| Treatment | Number of approaches | Standard error |
|---|---|---|
| Control | 1.00 | 0.00 |
| Polyethylene | 2.03 | 0.23 |
| Graphite | 1.74 | 0.16 |
| PVA | 1.25 | 0.12 |

TABLE 19
Time per approach to the plant as a function of fiber type

| | Mean time/approach | |
|---|---|---|
| Treatment | (Seconds) | Standard error |
| Control | 2.44 | 0.34 |
| Polyethylene | 29.37 | 5.63 |
| Graphite | 34.91 | 5.97 |
| PVA | 35.37 | 6.08 |

TABLE 20
Fiber type (graphite) influence on proportion of
unsuccessful plant acquisition (repels)

| Treatment | Proportion Repelled | Standard error |
|---|---|---|
| Control | 0.00 | 0.00 |
| Polyethylene | 0.55 | 0.06 |
| Graphite | 0.66 | 0.06 |
| PVA | 0.00 | 0.00 |

Under greenhouse choice conditions, fiber treatments reduced feeding damage in terms of actual leaf area removed by chewing (p=0.002; Table 21) and the proportion of the leaf damaged (p=<0.001; Table 22) with all treatments showing less damage than the control. No significant differences (p>0.75) were observed in laboratory color choice trials (blue, green, red, white and yellow polyester). There was no significant effect attributable to sex of the beetle, as determined through a posteriori dissection. Field studies comparing graphite fiber densities also showed a reduction in feeding damage in terms of actual leaf area removed by chewing (p<0.001; Table 23) and the proportion of the leaf damaged (p<0.001; Table 24).

TABLE 21
Under greenhouse choice condition,
fiber density influence on the total area
of leaf damages by an insect pest

| | Mean leaf | Standard |
|---|---|---|
| Treatment | Damage (cm²) | error |
| Control | 3.11 | 0.78 |
| 3 × 5 | 0.89 | 0.34 |
| 6 × 5 | 0.97 | 0.30 |
| 9 × 5 | 0.69 | 0.50 |

TABLE 22
Under greenhouse choice condition,
fiber density influence on proportion
of leaf damages by an insect pest

| | Mean Proportion | Standard |
|---|---|---|
| Treatment | Leaf Damage | error |
| Control | 0.44 | 0.07 |
| 3 × 5 | 0.15 | 0.06 |
| 6 × 5 | 0.17 | 0.06 |
| 9 × 5 | 0.07 | 0.04 |

TABLE 23
Graphite fiber density effect
on the total area of leaf damaged
by an insect pest

| | Mean leaf | Standard |
|---|---|---|
| Treatment | Damage (cm²) | error |
| Control | 1.72 | 0.40 |
| 1 × 5 | 1.30 | 0.24 |
| 3 × 5 | 1.07 | 0.19 |
| 6 × 5 | 0.68 | 0.14 |
| 9 × 5 | 0.43 | 0.15 |

TABLE 24
Graphite fiber density effect
on the proportion of leaf damaged
by an insect pest

| | Proportion | Standard |
|---|---|---|
| Treatment | Leaf Damage | error |
| Control | 0.44 | 0.07 |
| 1 × 5 | 0.40 | 0.07 |
| 3 × 5 | 0.32 | 0.06 |
| 6 × 5 | 0.24 | 0.05 |
| 9 × 5 | 0.09 | 0.03 |

### Radish—Epitrix

Beetles presented with a single, untreated or treated (3×5 cm graphite, polyethylene or electrostatically applied polyvinyl alcohol) radish seedling in no choice arenas differed significantly in their time course of plant acquisition. These differences between treatments occurred at 20 (p<0.001) and 30 (p<0.001) minutes after experiment initiation (Table 25). At other experimental times the beetle numbers are not significantly different among treatments. When the mean total number of observed beetles on plants for each treatment were analyzed, no significant differences were observed (p=0.558). However, for the proportion of the leaf damaged (p=0.025, proportional mean damage +se: control=0.17±0.05, polyethylene=0.13±0.04, graphite 0.05±0.02, PVA=0.23±0.04), PVA treatment significantly enhanced damage over the control and all other treatments. This was consistent with the rapid beetle buildup on PVA-treated plants during the experiments.

TABLE 25
Fiber Type influence on the time course of Flea Beetles in raddish acquisition
(particularly at 20 and 30 minutes)

| Time | | Control | | Graphite | | Polyethylene | | PVA Std. |
|---|---|---|---|---|---|---|---|---|
| (min) | Control | Std. Er. | Graphite | Std. Er. | Polyethylene | Std. Er. | PVA | Er. |
| 0.00 | 0.00 | 0.00 | 0.00 | 0.00 | 0.00 | 0.00 | 0.00 | 0.00 |
| 10.00 | 0.50 | 0.17 | 0.16 | 0.09 | 0.20 | 0.08 | 0.25 | 0.10 |
| 20.00 | 1.20 | 0.36 | 0.36 | 0.15 | 0.04 | 0.04 | 1.20 | 0.28 |
| 30.00 | 1.20 | 0.39 | 0.32 | 0.14 | 0.20 | 0.10 | 1.35 | 0.28 |
| 40.00 | 1.50 | 0.40 | 0.48 | 0.17 | 1.20 | 0.24 | 0.75 | 0.18 |
| 50.00 | 1.30 | 0.30 | 0.40 | 0.17 | 0.60 | 0.19 | 0.70 | 0.22 |
| 60.00 | 1.90 | 0.62 | 0.84 | 0.22 | 0.72 | 0.21 | 1.05 | 0.18 |
| 90.00 | 1.90 | 0.46 | 1.04 | 0.21 | 0.96 | 0.36 | 0.90 | 0.20 |
| 120.0 | 1.80 | 0.47 | 1.00 | 0.25 | 1.08 | 0.36 | 1.15 | 0.20 |

### EXAMPLE 3

### Efficacy of Various Fiber Barriers to Reduce Oviposition

### Materials and Methods

### Broccoli—Plutella and Delia

Greenhouse Trials

Laboratory-cultured diamondback moth pupae, placed in 12.07 cm diameter polystyrene containers and cabbage maggot pupae in 30.48×30.48×30.48 cm screen cages, were held under a 16:8 hr light cycle and 24° C. ambient temperature until eclosion. Adults of both sexes were then held together, under like conditions for at least 4 and 7 days, respectively, to allow both sexes to reach sexual maturity and mate. Adult insects were provided with a 10% sucrose-water solution ad libitum and cabbage maggots were additionally provided with a powdered baker's yeast mixture, as a protein source. Individuals were transferred to capped 4-dram glass vials before final transfer to test arenas. Laboratory and greenhouse arenas for Plutella and Delia were the same as those used for Acalymma and Diabrotica above, containing one (for behavioral experiments) or more (choice experiments) broccoli seedlings, hybrid broccoli-var. “Premium Crop” or var. “Southern Comet,” planted in a greenhouse potting mixture.

Fiber treatments were teased out over the seedlings (Plutella) or around the base of the seedling on top of the soil (Delia). Individual or multiple females of ovipositional age were used. The assessment of oviposition in Plutella involved the counting of eggs on individual seedlings in three areas (i.e., top and bottom of leaves including petiole and on the stem, i.e., below the petiole insertions) and on the fibers in the treated arenas. Determination of Delia oviposition involved the careful removal of each sub-container of substrate and placing them individually in water-filled containers. This allows the substrate to sink while the eggs in each container float and can be easily counted. Blocks (control+treatments) without eggs laid on control plants (Plutella) or within control containers (Delia) were not included in the analyses.

Field Trials

For field experiments involving Brassica, ten small cages (blocks) were erected over 5 transplanted (Plutella experiments) or potted (Delia experiments) broccoli seedlings in two alternating rows with 30.48 cm spacing between rows and plants within rows. For Plutella experiments, greenhouse-grown broccoli seedlings (with two cotyledons) were removed from a matrix of greenhouse potting mixture and planted directly into the soil within the cages. For Delia, broccoli seedlings were planted in potting mixture in 12.7-cm diameter standard pots to a depth of at least 3-cm below the rim. A 3 cm layer of a 10:4 mixture of #1 sand/topsoil was then placed over the top of the potting mixture containing the growing seedling as an oviposition substrate.

The five potted plants per cage were buried so that the brim of each pot was even with the surrounding soil. A 10% sucrose-water solution was provided in each cage along with a powdered brewer's yeast mixture in the Delia trials. Within each cage for choice tests, a single replicate of a control and four fiber treatments were applied (5 plants total). The behavior of caged insects (5-10 adult females/trial) was observed periodically to assess setup and insect viability. After 72 hours, the insects were removed and oviposition was assessed. For Plutella, number and position of eggs on each plant was measured. Start dates for field trials were July 18 and June 31 for density choice and August 6, August 14 and Sep. 18, 1996 for color choice. For Delia, the sand/topsoil mixture was removed and the eggs counted after flotation in water. Start dates for field trials were June 3 and Jun. 10, 1996. Blocks (control+treatments) without eggs deposited in control plots were not included in the analyses. Meteorological parameters including precipitation, wind velocity, and temperature, collected within 500 meters of experimental cages, were monitored during all field trials.

### Sweet Corn—Helicoverpa

Greenhouse Trials

To initially determine the spatial oviposition pattern of Helicoverpa on untreated sweet corn, four potted greenhouse-grown sweet corn plants, var. “Horizon,” in the silking stage with tassels and stems removed from about 30.48 cm above the silking ear, were placed in a wooden-framed, enclosed cage with a plywood bottom. The sectioned stem of each plant was sealed tightly with Parafilm™ (American National Can, Neenah, Wis.) to prevent desiccation and moderate volatile release. Four plants in each cage for fiber trials were treated by teasing out monofilaments over the silks of randomly assigned plants. Two pairs of unmated, but reproductively mature, male and female moths were released together in the oviposition cage for 96 hours. At the end of the experiment, the moths were removed and the position (stem, leaf, ear, silks and fibers if present) and number of eggs were recorded. Ambient temperature and time of day were tracked during laboratory and greenhouse trials. These trials were replicated nine times.

Field Trials

Two sweet corn plantings var. “Horizon,” 14 rows wide and 33.5 m in length with a 91.4 cm between-row spacing and 20.32 cm inter-plant spacing were planted on June 3 and Jun. 26, 1996. For field experiments involving Helicoverpa, five natural color HDPE or woven Lumite (Synthetic Industries, Gainesville, Ga.), 20×20 mesh screen cages were fabricated. Each cage was constructed to fit over a 2.9 m wide, by 3.8 m long, by 2.3 m high, 15.2-cm thick PVC frame. Cages were erected over the three center rows of each 7 rows of corn leaving two rows outside the cage on either side to minimize edge effect. Within each cage, all ears of sweet corn were removed from each plant in direct proximity to each the cage walls. All treatments and controls were confined to the ears of plants in the center row contained within this ear-removed buffer zone. Within each cage 16 plants were available, comprising a maximum of 4 replicates of a control and 3 fiber treatments for each cage in a trial. A food source of 10% sucrose-water solution in a vial with a dental wick, sealed with Parafilm™ and attached to a 1.8-m stake, was provided ad libitum. The five adult females and five adult male Helicoverpa, previously held together for 5-7 days to accommodate the pre-oviposition period, were released into each cage. Start dates for field trials were August 14, August 20, August 28, September 3 and Sep. 9, 1996. Sub-samples (control+treatments) without eggs on the silks of control plants were not included in the analyses. Meteorological parameters including precipitation, wind velocity and temperature (T°), collected within 500 meters of experimental cages, were monitored during all field trials. At the end of the 96-hour experimental period, moths were collected and individual control and fiber-treated plants were surveyed for the presence, number and position of eggs.

### Squash—Bemisia

Greenhouse Trials

Whiteflies were tested with a “No Choice” protocol using single treated and untreated summer squash plants var. “Seneca.” Two liter, polyethylene soda container arenas holding a single squash plant in a potting soil mixture were used for whitefly studies. Ten mating pairs of whiteflies were introduced into each arena for all studies. Up to forty arenas, depending on the treatment parameters of a given trial, were run simultaneously under identical ambient conditions. Ambient temperature and time of day were tracked during greenhouse trials. The length of each trial was 48 hours, at which point, the whiteflies were removed and the eggs counted on the top and bottom of each cotyledon and true leaf. Counts were made using a binocular dissecting scope.

The fibers for plant treatments were created and/or applied in four ways: 1) PVA fibers were electrostatically spun as a web directly onto squash plants, 2) sucrose cotton candy fibers were spun using a Robson Model CC 1-3701 (Chino, Calif.) cotton candy maker and applied by hand to the top and bottom of each cotyledon and true leaf, 3) “Off-the-Shelf” graphite fibers were teased by hand out at known densities (3×5 cm, 6×5 cm and 9×5 cm) over and around each cotyledon and true leaf and 4) ethylene vinyl acetate (EVA) was melt extruded under pressure into a stream of compressed air to form a fiber web directly onto the squash plant. While EVA, graphite and PVA fibers were relatively stable in greenhouse studies, the sucrose fibers were quickly degraded by moisture and formed a sugar coating of the leafs surface with numerous raised and stable sugar droplets. This was an expected result and the efficacy of this fiber application was worthy of testing.

### Broccoli—Pieris

Efficacy against Pieris (commonly known as imported cabbageworm) oviposition was tested using a Choice protocol with fiber treated and untreated squash plants var. “Seneca.” Four 2 liter, polyethylene soda container bottoms, each holding a single broccoli plant in a top soil mixture, were placed in each of five 45.7×47.5×45.7 cm screen cages used as test arenas (blocks). Three of the plants were treated with fibers and the fourth was an untreated control. Treatments were arranged randomly within each cage. Four, reproductively mature female Pieris were introduced into each arena for all studies, given a 10% sucrose solution as a food source and allowed to oviposit ad libitum. Ambient temperature and time of day were tracked during greenhouse trials. The length of each trial was 96 hours, at which point, the butterflies were removed and the eggs counted on the top, bottom and stem of each cotyledon and true leaf and on the fibers for treated plants.

The three fibers for plant treatments were created and/or applied in two ways: 1) ethylene vinyl acetate (EVA) fibers were melt extruded under pressure through a nozzle into a stream of compressed air forming a web that was then placed onto broccoli plants; or 2) either “Off-the-Shelf” graphite or black polyester fibers were teased by hand out at known densities (6×5 cm) over and around each cotyledon and true leaf.

### EXAMPLE 4

### Results of Oviposition Trials

### Broccoli—Plutella and Delia

Fiber type studies indicate that graphite fibers significantly reduced diamondback moth oviposition at 24 hours when compared with polyethylene-treated and untreated plants (p=0.0097; Table 26). The proportion of females ovipositing was reduced by the graphite fiber treatment (Table 27) along with a significant change in the spatial egg deposition pattern (Table 28). In an additional fiber type trial, electrostatically-spun, PVA fibers did not reduce total oviposition on broccoli seedlings (p=0.257) from that of untreated, polyethylene- and graphite-treated seedlings even though oviposition was lowest for PVA on each plant area and significantly so for the bottom (p=0.005). This was due to the significantly greater egg deposition on the PVA fibers themselves (p<0.001; mean number of eggs±se: PVA=105.42±27.84, polyethylene=11.27±5.76,graphite=23.40±8.70). This does not equate to increased plant protection since newly hatched larvae were then able to penetrate the PVA barrier and feed on the leaves. Significantly more eggs were recorded on control plants than those treated with a medium (6×5 cm) or a high (9×5 cm) level of fibers at 3 hr (p=0.0482) and 6 hr (p=0.0231).

TABLE 26
The influence of graphite fiber treatment
on oviposition over a 24 hour period

| | Mean | Standard |
|---|---|---|
| Treatment | Oviposition | error |
| Control | 18.60 | 6.09 |
| Polyethylene | 18.07 | 4.26 |
| Graphite | 3.87 | 1.84 |

TABLE 27
The effect of fiber type
on the proportion of female pests ovipositioning

| | Total |
|---|---|
| | Proportion |
| Treatment | Ovipositioning |
| Control | 0.87 |
| Polyethylene | 0.87 |
| Graphite | 0.40 |

TABLE 28
The effect of fiber type on the spatial pattern of egg deposition

| | Mean | | Mean | | | |
|---|---|---|---|---|---|---|
| | Ovi- | Top | Ovi- | Bottom | Mean | Stem |
| | position | Std. | position | Std. | Oviposition | Std. |
| Treatment | Top | Error | Bottom | Error | Stem | Error |
| Control | 7.67 | 3.04 | 10.73 | 3.92 | 0.20 | 0.15 |
| Polyethylene | 6.07 | 1.54 | 12.00 | 3.45 | 0.00 | 0.00 |
| Graphite | 1.27 | 0.57 | 2.00 | 1.13 | 0.60 | 0.60 |

In choice studies, color had a significant effect on egg placement, with plants treated with blue fibers less preferred (p=0.040; mean number of eggs±se: blue=0.92±0.61, white=13.08±5.06, burgundy=9.92±3.89). No significant differences were noted in separate no choice tests of untreated, green and yellow polyester (p=0. 1214). Oviposition was significantly reduced in graphite density choice polyester fibers tests (p<0.001; range of mean number of eggs±se: control=127.33±1.73, 6×5 cm=9.75±6.96) with 3 of 12 blocked replicates exhibiting oviposition only on the untreated plants and 6 of the 12 with oviposition only on untreated and low density treatments. Positional oviposition data (top, bottom, stem, fibers) was also recorded with similar results for each fiber treatment (p=0.0012<0.001).

Field studies testing graphite density (untreated, 1×5, 3×5, 6×5, and 9×5 graphite tow) showed a significant reduction in mean total oviposition with increasing density (p<0.001; Table 29). This was consistent with the results when each plant location (top: p<0.001, bottom: p<0.001, and stem: p<0.001) was considered individually. The number of eggs laid on the test fibers also decreased significantly with increasing density (p=0.046; Table 30). No significant differences (p=0.731-0.089) were observed in field color choice trials (blue, green, red, white and yellow polyester).

TABLE 29
Increasing fiber density acts
to change the pests' total oviposition on the plant

| | Total | Standard |
|---|---|---|
| Treatment | Number of Eggs | error |
| Control | 42.79 | 11.76 |
| 1 × 5 | 25.79 | 11.05 |
| 3 × 5 | 14.64 | 10.60 |
| 6 × 5 | 2.07 | 1.18 |
| 9 × 5 | 0.86 | 0.49 |

TABLE 30
Increasing fiber density acts to
change the pests' ability to lay eggs on the plant

| | Total | Standard |
|---|---|---|
| Treatment | Number of Eggs | error |
| 1 × 5 | 14.07 | 8.44 |
| 3 × 5 | 4.21 | 3.56 |
| 6 × 5 | 1.64 | 1.15 |
| 9 × 5 | 0.36 | 0.29 |

Initial greenhouse cage studies of cabbage maggot females showed that 96.4% of all eggs were deposited within 1.25 cm of an untreated host plant. These studies also outlined the behavioral oviposition sequence for Delia, documenting the fly's need for tactile contact with the host plant during its ovipositional sequence. These data were useful in comparisons of oviposition with increasing fiber densities, and other Delia studies. In fiber type studies, graphite fibers significantly reduced oviposition within 1.25 cm of the stem when compared with polyethylene treated and untreated plants (p=0.0126; Table 31).

TABLE 31
Fiber type affects oviposition in soil around the plant stem

| | | Control | Poly- | Poly- | | Graphite |
|---|---|---|---|---|---|---|
| Distance | | Std. | eth- | ethylene | | Std. |
| (cm) | Control | Error | ylene | Std. Error | Graphite | Error |
| <1.25 | 4.73 | 1.65 | 2.80 | 1.06 | 0.07 | 0.07 |
| 1.26-2.50 | 0.13 | 0.09 | 0.40 | 0.21 | 0.27 | 0.18 |
| 2.60-3.00 | 0.07 | 0.07 | 0.07 | 0.07 | 0.07 | 0.07 |
| 3.10-3.50 | 0.00 | 0.00 | 0.07 | 0.07 | 0.47 | 0.47 |

In addition, the proportion of females ovipositing within 1.25 cm of the stem was reduced, particularly by the graphite treatment, which was responsible for a reduction from 80% for untreated plants to less than 10% (Table 32). In separate laboratory fiber type trials including plants treated with electrostatically-spun PVA fibers, oviposition within the 1.25 cm of the stem was significantly reduced (p=0.027; Table 33). A significantly greater proportion of eggs were deposited within 1.25 cm of an untreated stem than for graphite, polyethylene or PVA treatments (p=0.004). Trials with broccoli seedlings covered with electrostatically-spun, polyvinyl alcohol fibers indicate that as long as the “web” formed by the 0.5 μm fibers remains intact, oviposition by cabbage maggot is prevented. Small rips or tears, in some of our PVA treatments, allowed females to contact the stem and accomplish oviposition. Still the result presents the efficacy of electrostatically spun and biodegradable fiber barriers against cabbage maggot. Oviposition within 1.25 cm of a stem declined significantly with increasing density (3×5, 6×5, 9×5) of graphite fibers (p=0.0043; Table 34). A reduction in total eggs (p<0.001) per female was also noted. The proportion of females ovipositing was reduced by increasing fiber density particularly within the inner 1.25-cm radius (Table 35). Laboratory trials showed no significant effect of color on cabbage maggot oviposition. When given a choice, untreated plants were subject to more oviposition than those treated with fibers (p<0.001; egg mean±se: control=12.93±13.78, high density-0.53±0.19) and oviposition near the stem than treated plants (p<0.001; egg mean within 1.25 cm±se: control=10.07±3.78, high density 0.27±0.15).

TABLE 32
The proportion of pests ovipositioning within 1.25 cm
of the stem as a function of fiber barrier type

| | Proportion | Proportion |
|---|---|---|
| | Ovipositioning | Ovipositioning |
| Treatment | Total | Inner |
| Control | 0.80 | 0.80 |
| Polyester | 0.53 | 0.40 |
| Graphite | 0.33 | 0.07 |

TABLE 33
Fiber type influence on egg deposition within 1.25 cm
of the stem (laboratory trials)

| | Total number | Standard |
|---|---|---|
| Treatment | Eggs (1.25 cm) | Error |
| Control | 0.80 | 3.64 |
| Polyethylene | 0.20 | 0.20 |
| Graphite | 0.00 | 0.00 |
| PVA | 0.40 | 0.40 |

TABLE 34
Increasing graphite fiber density influence on average oviposition

| | | | | | | Me- | | |
|---|---|---|---|---|---|---|---|---|
| | | Control | | Low | | dium | | High |
| Distance | | Std. | | Std. | Me- | Std. | | Std. |
| (cm) | Control | Error | Low | Error | dium | Error | High | Error |
| <1.25 | 4.09 | 1.64 | 1.18 | 0.99 | 0.46 | 0.46 | 0.18 | 0.12 |
| 1.26-2.50 | 0.73 | 0.24 | 0.64 | 0.34 | 0.46 | 0.25 | 0.00 | 0.00 |
| 2.60-3.00 | 0.64 | 0.28 | 0.18 | 0.12 | 0.09 | 0.09 | 0.00 | 0.00 |
| 3.10-5.50 | 1.00 | 0.56 | 0.27 | 0.20 | 0.55 | 0.28 | 0.09 | 0.09 |

TABLE 35
The effect of increasing fiber density
on both total oviposition and oviposition within 1.25 cm of the stem

| | Proportion | Proportion |
|---|---|---|
| | Ovipositioning | Ovipositioning |
| Treatment | Total | Inner |
| Control | 1.00 | 1.00 |
| 3 × 5 | 0.66 | 0.23 |
| 6 × 5 | 0.38 | 0.00 |
| 9 × 5 | 0.23 | 0.18 |

### Sweet Corn—Helicoverpa

Greenhouse cage studies in which fibers were teased over silks of the corn suggested that jute might significantly reduce, while graphite fibers significantly enhance oviposition in the area around the ear silks when compared with untreated plants (p=<0.001; oviposition proportion mean±se: control=0.13±0.05, jute=0.00±10.00, graphite=0.28±0.05; number of eggs 407). Field fiber type studies performed in large cages, showed a significant reduction only in mean proportional oviposition with differing fiber types (p=0.019; Table 36). Despite this apparent deflection of earworm spatial oviposition pattern, both the mean proportion of eggs on the silks and fibers if present (eggs on silks+eggs on fibers/total eggs on plant+fibers; p=0.955) and the mean total eggs per plant+fibers (p=0.207) exhibited non-significant treatment effects.

TABLE 36
Fiber type effect on the proportion of oviposition
on the silk of the corn plant

| | Proportion | Standard |
|---|---|---|
| Treatment | of eggs on silks | Error |
| Control | 0.65 | 0.13 |
| Polyethylene | 0.33 | 0.12 |
| Graphite | 0.14 | 0.08 |
| Jute | 0.30 | 0.11 |

### Squash—Bemisia

Under no choice conditions all three treatments significantly reduced whitefly oviposition. Significant differences were recorded between the mean oviposition for untreated and graphite fiber treated squash plants (p=0.0001; Table 37) with a steady reduction in the mean total number of eggs with increasing fiber density. Likewise, the total mean number of eggs/plant (p=0.0001, control =24.47±1.88 versus sucrose=5.87±1.96; Table 38) was significantly reduced by sucrose treatment. The results of the PVA trial show a significant reduction in mean total number of eggs laid between untreated and treated plants (p=0.0174, control =54.89±8.17 versus PVA =30.78±4.83). Significant differences in egg location are statistically supportable, as well (Table 39). Untreated plants exhibited significantly more whitefly oviposition on true leaves (p=0.0016) and significantly less oviposition on the cotyledons (p=0.0001) than untreated plants. No significant differences were observed in whitefly oviposition on untreated and EVA-treated squash seedlings (p=0.940).

TABLE 37
In the greenhouse, the effect of graphite fiber density
on mean oviposition by Silverleaf Whiteflies on squash plant

| Treatment | Total # of eggs | Standard error |
|---|---|---|
| Control | 24.0 | 5.31 |
| 3 × 5 | 11.5 | 2.79 |
| 6 × 5 | 8.6 | 2.62 |
| 9 × 5 | 4.8 | 1.89 |

TABLE 38
The effect of spun sucrose on total mean oviposition
by Silverleaf Whiteflies on squash plant

| | | Standard |
|---|---|---|
| Treatment | Total # of eggs | Error |
| Untreated | 24.467 | 2.882 |
| Sugar | 5.867 | 1.964 |

TABLE 39
The effect of PVA on the mean amount and location
of oviposition by Silverleaf whiteflies on squash plant

| | | Control | | PVA |
|---|---|---|---|---|
| Plant/Leaf | Control | Standard Error | PVA | Standard Error |
| Plant | 62.1 | 11.559 | 39.7 | 6.53 |
| True Leaves | 53.3 | 10.519 | 6.2 | 4.046 |
| Cotyledons | 7.6 | 2.172 | 33.3 | 6.603 |

Under choice conditions, all three treatments significantly reduced the total mean number of eggs/plant (p=0.0002; see Table 40) laid by imported cabbageworm. In addition, ethylene vinyl acetate prevented oviposition significantly better than the “off-the-shelf” treatments, perhaps due to its better coverage of plant tissue. Decreased oviposition was primarily due to significant reductions in the number of eggs laid on the bottoms of the leaves (p=0.0001; see Table 41). Fiber treatments may present particular difficulties for egg laying on the underside of the leaves by eliminating adequate leaf-edge perches.

TABLE 40
Effect of fiber treatments on
Mean total imported cabbageworm oviposition

| | Mean Total Number | Standard |
|---|---|---|
| Treatment | of eggs | Error |
| EVA | 4.8 | 3.6 |
| Black polyester | 14.2 | 3.7 |
| Graphite | 17.0 | 6.2 |
| Control | 27.4 | 4.8 |

TABLE 41
Effect of fiber treatments on
mean imported cabbageworm leaf underside oviposition

| | Mean Total Number | Standard |
|---|---|---|
| Treatment | of eggs | Error |
| EVA | 2.6 | 2.6 |
| Black polyester | 8.2 | 3.6 |
| Graphite | 13.0 | 5.4 |
| Control | 20.0 | 4.4 |

### EXAMPLE 5

### Fibrous Deterrents for Molluscs

Several trials have been conducted using a copper impregnated fibrous deterrent to discourage slugs from feeding on vegetable baits.

Trial 1, May. 24, 2000:

Slugs were field collected from two locations, Hector N.Y. and Freeville N.Y., and appeared to be both brown banded slugs and gray garden slugs. Positive identification was not done. The slugs were placed in a 10 gallon aquarium whose bottom was lined with gravel that was then covered with moss. An acrylic plate was paced on the moss and three treatments placed on the acrylic. Belgian endive leaves were placed onto 1) the acrylic plate (control), 2) an ethylene vinyl acetate (EVA) fiber mat, or 3) onto an EVA fiber mat dusted with 150 mesh copper pellets (Sigma-Aldrich). After overnight feeding, all treatments showed substantial feeding.

Trial 2, May 25, 2000

This trial used the same experimental setup as above but copper foil was used as an additional treatment. The endive was examined after overnight feeding, and all treatments showed some damage. Subjective ratings showed that copper foil treatments had less damage than copper dust treatments, but both had less feeding damage than EVA alone or endive alone.

Trial 3, May 26, 2000

To test whether it might be affecting results, the acrylic plate was removed and replaced with a damp brown paper towel over the moss. Six cabbage discs (22.5 mm) were placed on four treatments located on top of the paper towel: 1) copper foil, 2) EVA fiber mat+copper powder, 3) EVA fiber mat alone, and 4) paper towel alone.

Damage was subjectively evaluated on May 28, 2000. Treatments 1 and 2 had approximately 15-20% damage, but treatments 3 and 4 were 100% consumed.

Trial 4, Jun. 1, 2000

The setup was similar to Trial 3, but treatments were spatially rearranged. Damage was again visually estimated. Copper foil deterred slugs the most, limiting damage to approximately 15% on one cabbage disc. Copper powder in a fiber matrix limited damage to about 30% on all discs. Damage to cabbage on EVA was about 90% and damage was 100% on cabbage placed directly on the paper towel.

Trial 6, Sep. 9, 2000

This trial was conducted in a growth chamber held at 85° F. and approximately 80% RH. Children's wading pools (approx 3 foot diameter) were filled with an inch or two of potting soil. The rims of the pools were coated with a salt-sugar mix to prevent slug escape. A copper-fiber barrier was made by spraying Elmer's Craft Bond Spray Glue onto a spun bonded polyester row-cover and dusting it with 150 mesh copper powder. Three pools served as controls. Each of these controls had a strip (8 inches) of untreated row cover across the soil. Three pools served as copper treatments and had a strip (8 inches) of copper dusted row cover across the soil. Twenty-five grams of cabbage was placed on one side of each strip and slugs (approximately 15 per replicate) were placed on the other. Damage to cabbage was evaluated after a few days.

In this trial, two of the copper replicates were untouched, and one was slightly eaten. In contrast, all of the controls were heavily damaged. The mass of cabbage for three replicates is given below in Table 42. Moisture loss accounted for most of the decline in mass, but loss due to feeding was especially evident in the replicate where no copper resulted in 100% consumption of cabbage.

TABLE 42

| Treatment | Mass of Cabbage (g) | | |
|---|---|---|---|
| copper | 6 | 8 | 5 |
| no copper | 5 | 4 | 0 |

Differences between treatments were apparent.

Therefore, it appears that a copper-fiber matrix shows promise for deterring slugs (snails). Some exposure to copper may be necessary before its deterrent effect becomes apparent. Other metals may prove effective, for example, zinc is also toxic to terrestrial molluscs. A fiber backed foil may be particularly effective. Methods that increase exposure time, such as reticulation, may improve efficacy.

Later Trials

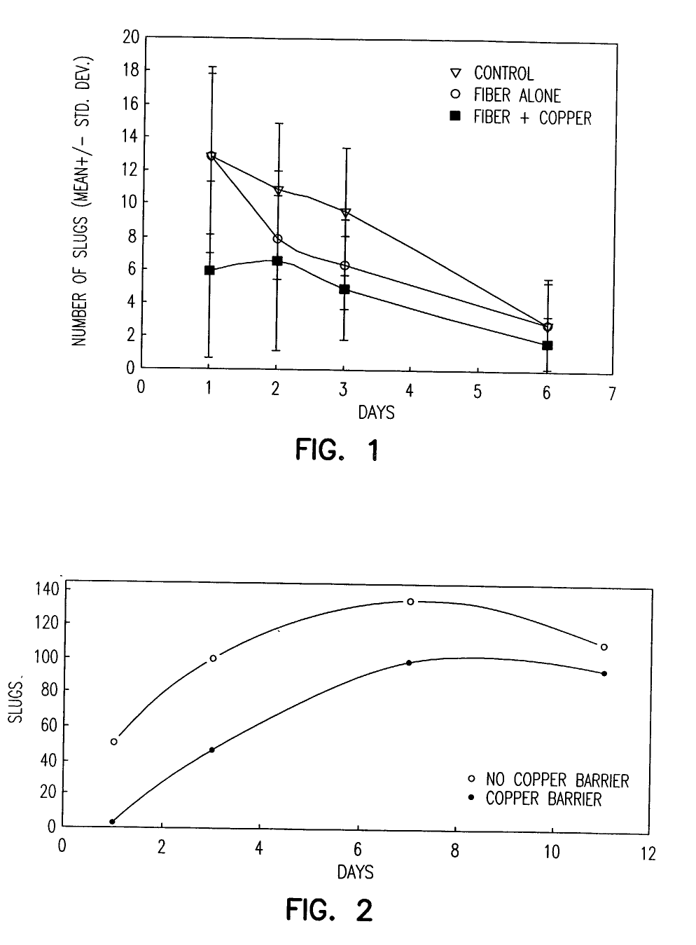

Experiments were conducted to evaluate the feasibility of using non-woven fiber fabric with affixed copper granules for the purpose of excluding terrestrial molluscs from specific areas. Spun bonded polyester fabric was coated with >100 mesh copper granules and placed in the field in a completely randomized design with 5 replicates of each treatment. Controls were no fabric. Additional comparisons were made against fabric with no copper affixed. Slug counts were performed 1, 2, 3, and 6 days after treatments were placed in the field. Copper granules reduced the number of slugs counted within a 10 inch×20 inch area that was baited with tomato sections (FIG. 1). Repeated measures analysis of variance indicated a time by treatment effect (Wilks' Lambda F=2.58 P=0.0211).

Additional experiments were conducted to evaluate the efficacy of copperized fabric for the purpose of excluding terrestrial mollusc from a commercial pea crop. Slugs were counted in peas with and without a copperized fabric barrier. Copper granules were affixed to spun-bonded polyester row cover that was used to surround pea plants. The barrier was approximately 12 inches wide and surrounded a 6 foot section of peas. Slugs inside the barrier were counted over time to evaluate immigration into the plots. Slug immigration was reduced by copper deterrents, but differences appeared to decline over time (FIG. 2).

### EXAMPLE 6

### Non-Woven Fiber Barriers for Control of Cabbage Maggot and Onion Maggot (Diptera: Anthomyiidae)

The cabbage maggot, Delia radicum (L.), and onion maggot, Delia antiqua (Meigen), are serious worldwide pests of cruciferous and Allium crops, respectively. Chemical control options for these pests are limited because of resistance problems and de-registration of many currently effective compounds. A novel approach to managing D. radicum and D. antiqua using non-woven fiber barriers was investigated from 1996 to 2000. The barriers consisted of arrangements of minute fibers loosely intertwined in “web” form. The fibers interfere with insect searching and alighting behavior, such that oviposition is minimized. We conducted greenhouse and field experiments using commercially-available graphite fibers as well as ethylene vinyl acetate (EVA) fibers created from a melt extrusion process. Also we investigated the potential to enhance fiber efficacy with the incorporation of color pigments, optical brighteners, and capsaicin repellent. Our results showed that non-woven fibers applied to the base of broccoli and onion plants significantly reduced the number of cabbage and onion maggot eggs laid and larvae infesting plants. In the field, fiber barriers provided comparable control to standard insecticide applications. Efficacy increased with fiber density. Addition of color pigments, optical brighteners, or capsaicin oleoresin did not enhance fiber efficacy in our experiments. Non-woven fiber barriers offer an alternative to insecticides for control of cabbage maggot and onion maggot, and may offer a management solution to a number of pest problems. Additional research is needed to improve the application process, identify biodegradable compounds for fibers, and identify other potential uses for the fiber barriers.

We report here our research on the use non-woven fiber barriers, intertwined in “web” form, and applied in situ for control of cabbage maggot and onion maggot. In addition, we evaluate the potential to enhance fiber efficacy with the incorporation of color pigments, optical brighteners, and capsaicin repellent.

Materials and Methods

Several greenhouse and field experiments on the use of non-woven fibers as an oviposition deterrent for D. radicum on broccoli and D. antiqua on onions were conducted. All greenhouse studies were conducted at the Cornell University Insectary Building under a combination of daylight and grow-lights on a 16:8 hour light:dark regime and ambient temperatures from 24 to 30° C. Most field experiments were conducted at the H. C. Thompson Vegetable Crops Research Farm near Freeville, N.Y.

All D. radicum and D. antiqua used in the experiments were obtained from colonies maintained at the Department of Entomology, New York State Agricultural Experiment Station, Geneva, N.Y. As needed, pupae were placed in separate 0.3 m³ emergence cages at 23° C., 40% relative humidity (RH) and 16:8 light:dark (L:D). Emerged adult flies were provided with a 10% sucrose solution, Holland Dry Diet and Brewers yeast ad libitum, and allowed to mate. Female D. radicum or D. antiqua were aged 7 to 9 days post-eclosion (reproductively mature) prior to their use in trials.

Development and optimization of a fiber delivery system. In order to generate fibers in situ, we fabricated a small-scale prototype machine that produced fibers of ethylene vinyl acetate (EVA) (Elvax 200W or 205W, Dupont Polymers, Wilmington, Del.) by a melt extrusion process. Hydraulic pressure was used to extrude molten EVA through a small orifice and the fibers were carried to the target by a stream of air. The melt-extrusion apparatus consisted of a metal reservoir (160×100 mm) that was heated to about 150-180° C. and pressurized to about 172.4 kPa with CO₂ gas. The pressure forced the molten EVA through a 2-mm ID nozzle orifice located near the base of the reservoir. Fibers from this prototype unit ranged from ˜20-250 μm in diameter.

Subsequently, we obtained commercial equipment to generate EVA fibers via melt extrusion. The equipment (manufactured by ITW Dynatec, Hendersonville, Tenn.) was designed to apply hot melt glue in industrial settings. It was selected for our trials because it allowed us to easily generate a range of fiber characteristics by varying temperature, pressure, and nozzle configuration. The equipment consisted of a Dynamini™ adhesive supply unit fitted with a pneumatic piston pump, and a 3.7-m Dynaflex™ hose and a Dynagun™ hot melt applicator MODEL 155 fitted with a 0.787 mm Dynaswirl™ nozzle orifice. The unit required an air compressor and was powered in the field by a generator. The EVA fibers generated ranged from 5 to 50 μm in diameter.

When used in trials, fibers produced by the Dynatec system were applied directly to the soil around the plant's base with coverage patterns similar to that of hand-teased commercially available fibers. The hose, spray gun, and hopper containing EVA were maintained at about 170° C. during application. The resulting non-woven barriers were three dimensional, bound coarse web mats the height of overlapping fibers of varying strand number and amount of reticulation. The Dynatec unit also permitted us to produce fibers made from various compound mixtures and of various colors.

EVA fibers/onion maggot field-cage experiment. In mid-June 1998, the effectiveness of in situ generated EVA was tested against onion maggots in a large (2.7×3.7×2.4-m) field cage covered with natural-color Lumite( (HDPE) (Hansen WeatherPort® Corp., Gunnison, Colo.). Ten to eleven greenhouse-grown three-leaf stage onion plants cv ‘Stuttgart’ were transplanted into each of four plastic rain gutters (2.74 m long×0.10 m wide×0.07 m deep), which were buried in trenches and filled with a 10:4 sand:top soil mixture to match the existing soil level in the cage. Plants were spaced about 25 cm apart in the gutters, with 0.6 m between the gutters.

Within each gutter, four randomly-chosen plants were treated with EVA and another four not treated. Plants located at the ends of rows were not used. EVA treatments were applied with the Dynatec melt extrusion unit with pneumatic pressure to the fluid pump at 413.7 kPa and air supply to the nozzle set at 275.8 kPa. Fiber applications were completed in about 3 sec and ranged from 1 to 2 g/plant.

Twenty female D. antiqua flies were released into the cage and a 10% sucrose solution was provided ad libitum. After 72 hrs onion maggot egg numbers were sampled by removing a cylinder of soil (5.0 cm radius×7.6 cm deep) around each plant and washing and sieving the soil and plant material as described previously. Total number of eggs per plant was recorded.

Fibers+optical brightener/cabbage maggot field-cage experiment. Optical (fluorescent) brighteners are widely used in paints, fabrics, plastics and detergents, wherein they enhance the apparent brightness of the material by absorbing UV radiation and emitting light in the blue visual spectrum (Martinez et al. 2000). These brighteners were feasible to use with our existing technology and could potentially increase fiber effectiveness. Thus in mid-May 2000, we tested the efficacy of optical brighteners added to EVA fibers against cabbage maggots in four large (3.7×3.7×1.8-m) Lumite® field cages. The experiment was a randomized complete block design with four replicates (cages).

Within each cage, six rows (3-m long) were formed about 0.3-m apart by hand plowing. Greenhouse-grown two-leaf stage broccoli cv ‘Southern Comet’ was transplanted into the 6 rows within each cage at a plant spacing of 15 cm. One row of broccoli represented a single treatment within each cage. The six treatments were as follows: 1) EVA at low rate (=3.7 g per 3-m row); 2) EVA at high rate (=7.4 g per 3-m row); 3) EVA+0.05% Optiblanc™ SPL-10 optical brightener (Lenape Industries, Inc., Hillsborough, N.J.) at low rate; 4) EVA+Optiblanc at high rate; 5) chlorpyrifos applied as a soil drench at 0.033 kg ai/100 row m (grower standard); and 6) an untreated control. Fiber treatments were applied with the Dynatec melt extrusion unit at a pump pneumatic pressure=138 kPa and nozzle pneumatic pressure=552 kPa. Once applied, fibers encompassed a 15 to 20 cm band at the base of the broccoli seedlings.

On May 21 , approximately 175 D. radicum pupae were released into each of the four cages and 10% sucrose solution was provided as a food source for emerging adults. After about 2 weeks, broccoli plants were sampled for cabbage maggot larvae and pupae by digging up roots and soil around each plant and washing the material through a No. 60 USA standard testing sieve. Total number of larvae and pupae per plant was recorded.

Fibers+optical brightener/onion maggot on-farm experiments. In spring 2000, the effectiveness of EVA fibers with and without optical brighteners was tested against D. antiqua on two commercial onion farms, one in Potter, N.Y. and the other near Oswego, N.Y. The same treatments were tested at each location in a randomized complete block design with four replicates.

In early April, onions cv ‘Gazette’ were planted on “muck” soils using a push-behind Earthway™ Precision Garden seeder model 1001-B (EarthWay Products, Inc.; Bristol, Ind.). Individual plot sizes were 2 rows by 4.6 m. Plants were 10-cm apart within rows. The six treatments were as follows: 1) EVA at low rate (=3.7 g per 3-m row); 2) EVA at high rate (=7.4 g per 3-m row); 3) EVA+0.05% Optiblanc™ SPL-10 optical brightener at low rate; 4) EVA+Optiblanc at high rate; 5) Fipronil seed treatment at 50 g ai/kg seed, which is currently the most efficacious insecticide treatment for onion maggot (Eckenrode et al. 2000); and 6) an untreated control. All EVA treatments were applied when onion plants were 3-6 cm tall (early to mid May) using the Dynatec melt extrusion unit as described previously. Once applied, fibers encompassed a 15 to 20 cm band at the base of the onion seedlings.

Cumulative readings of damaged and wilting plants, plus onion maggot numbers were made weekly from late May to late June. Data were collected from the center 3-m of row in each plot. At each sample date, the number of total plants, number of wilted plants+dead seedlings, and the number of maggot larvae in dead seedlings were counted.

Fibers+capsaicin/cabbage maggot field experiment. Capsaicin is present in an oleoresin mammal repellent made from piquant chili peppers. Oleoresin capsaicin was added to EVA fibers and tested it against D. radicum in a field experiment. The experiment was a completely randomized design with 8 replicates.

On Jun. 26, 2000, land at the Freeville farm was cultivated, fertilized with 15-15-15, and 4 rows (beds) were made 1-m width apart. Greenhouse-grown two-leaf stage broccoli cv ‘Southern Comet’ was transplanted into the rows at a plant spacing of about 0.2 m. Individual plot size was 1 row by 4.8 m. Six treatments were tested and were as follows: 1) EVA at low rate (=3.7 g per 3-m row); 2) EVA at high rate (=7.4 g per 3-m row); 3) EVA+capsaicin oleoresin (1:6 ratio, 1.6 M-Scoville Heat Units) at a low rate; 4) EVA+capsaicin at high rate; 5) chlorpyrifos applied as a soil drench at 0.033 kg ai/100 row m; and 6) an untreated control. Fiber treatments were applied as described previously.

On July 21, five randomly-chosen broccoli plants from each plot were dug up. The root systems of each plant plus about 1200 ml of surrounding soil were sampled for cabbage maggot larvae and pupae by washing and sieving as described previously.

Statistics. Data from each experiment were analyzed using ANOVA. When appropriate, data were square-root or arcsine-square root transformed to stabilize variances prior to analyses (Ott, 1984). Fisher's protected LSD was used to separate treatment means at the 0.05 level of significance.

Results

EVA fibers/onion maggot field-cage experiment. Applying EVA fibers to onion plants and the surrounding soil surface significantly reduced the number of onion maggot eggs found (F=15.62; df=1, 27,p=0.0005). EVA-treated plants had a mean±SE of 1.4±0.6 eggs compared with 10.4±2.1 eggs for the untreated plants. Fibers did not restrict growth of the onion plant or cause any apparent phytotoxicity.

Fibers+optical brightener/cabbage maggot field-cage experiment. Applying EVA fibers to 2-leaf stage broccoli plants and the surrounding soil appeared to restrict leaf unfurling for a period of time (1-2 weeks), but as plants grew, the leaves broke through the fiber barrier and were subsequently unaffected by the fiber mat. While treatment of the fiber barriers with this optical brightener under these conditions did not have a statistically significant effect on number of cabbage maggots found on broccoli plants (F=1.79; df=5, 15,p=0.217), the untreated broccoli plants averaged more than twice as many maggots as the high rate treatments of either pure EVA or EVA+optical brightener (Table 43). Accordingly, different application procedures and different brighteners may increase the efficacy of this approach.

Fibers+optical brightener/onion maggot on-farm experiments. Onion maggot population levels were low in New York in 2000. The two on-farm experiments did not have sufficient D. antiqua pressure to adequately evaluate the fiber treatments. No maggots were found at the Oswego site, and at the Potter location, there was no significant treatment effect on number of maggots (F=1.56; df=5, 15,p=0.231) or % of wilted plants (F=1.97; df=5, 15,p=0.142). Although these experiments were not an adequate evaluation of onion maggot control, on-farm testing did provide us with some qualitative information on the feasibility of applying fibers in the field. Some initial restriction of plant growth by the EVA fiber mat was observed, but most of the onion seedlings poked through the fibers by the 2^{nd} or 3^{rd} true-leaf stage. And were subsequently not affected by the fibers.

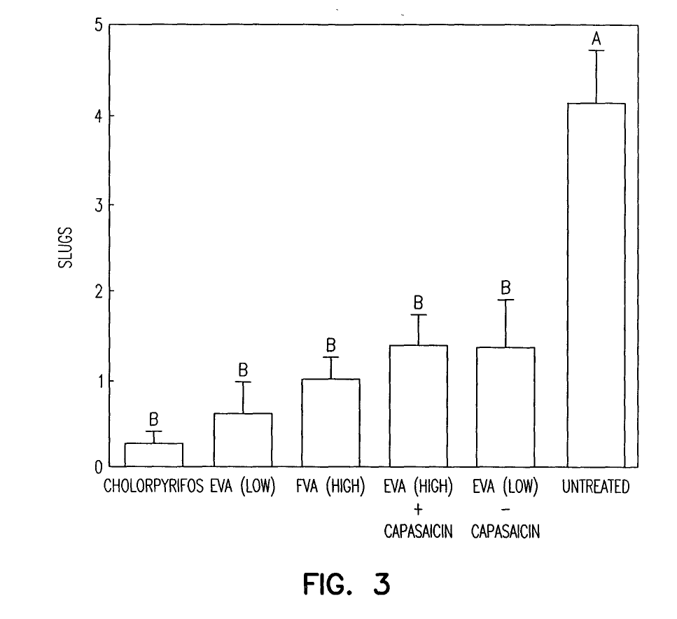

Fibers+capsaicin/cabbage maggot field experiment. Applying EVA fibers to broccoli plants and the surrounding soil had a highly significant effect on number of cabbage maggots infesting the plants (F=10.42; df=5, 40, p=0.0001). Two plots were removed from the data set because of human error during the wash and sieving process. All fiber treatments had significantly fewer maggots per plant compared with the untreated control and were not significantly different than the chlorpyrifos application (FIG. 3). The addition of capsaicin oleoresin did not provide a statistically significant improvement over the efficacy of the EVA fibers.

TABLE 43
Effect of ethylene vinyl acetate (EVA) fiber treatments
applied at the base of broccoli plants for control of
D. radicum in a field-cage experiment using
artificially-released flies.

| | | D. radicum larvae |
|---|---|---|
| Treatment | Rate | per 3-m row of broccoli |
| Non-treated control | — | 11.8 ± 3.1 |
| EVA | 3.7 g per 3-m row | 7.8 ± 1.3 |
| | 7.4 g per 3-m row | 3.8 ± 0.6 |
| EVA + optical | 3.7 g per 3-m row | 7.8 ± 2.7 |
| brightener¹ | 7.4 g per 3-m row | 5.5 ± 2.4 |
| Chlorpyrifos drench | 0.033 kg ai/100-m | 6.0 ± 2.3 |
| | row | |

¹Optiblanc ™ SPL-10 optical brighteners (Lenape Industries, Inc., Hillsborough, NJ) were mixed with melted EVA at a rate of 0.05%. In this experiment, treatment effect of fibers was not significant on cabbage maggot numbers (F = 1.79; df = 5, 15, p = 0.217) according to ANOVA.

Non-woven fiber barriers therefore hold considerable potential for the management of D. radicum and D. antiqua. Results of greenhouse and field experiments showed that non-woven fibers applied to the base of plants substantially reduced the number of eggs or larvae of D. radicum on broccoli and D. antiqua on onions. Efficacy increased with fiber density. In the field, fiber barriers provided comparable control to standard insecticide applications. Using a commercial melt extrusion applicator (Dynatec system), an effective method for on-site creation of non-woven barriers has therefore been devised.

### EXAMPLE 7

### Fibrous Barrier Control of Blackbirds

This Example provides data illustrating that obstructive non-woven fiber barriers can provide an ecologically sound method of reducing damage caused by blackbirds and can compliment conventional techniques to form an integrated pest management program.

### Materials and Methods

Capture and Maintenance of Study Animals

Blackbirds were captured at roosting sites near Freeville (1997), and Spencer (1998), in central New York State, between late August and mid-September. Blackbirds had been observed feeding in sweet corn fields near both of these roosts. Birds were captured using 6-cm mesh mist nets. The Freeville site was a marshy area, and the net location was within walking distance from an access road. At Spencer, the blackbirds roosted on cattails (Typha spp.) growing in a shallow lake, necessitating the use of a canoe to access the net site. At both sites, the mist nets were erected in the late afternoon. At Freeville, birds were captured as they came in to roost. This technique was unsuccessful at Spencer, so shortly after the birds had settled to roost, they were herded toward the net. Adults were preferable for the study because they tend to cause more damage to sweet corn than do immature birds (Dolbeer, pers. comm.) due to their greater experience. However, adults were rarely captured in the nets, so sixteen sub-adults (eight males, eight females) were used for the trials in 1997 trials, and four adult males and eight sub-adults (five males, three females) were used for those in 1998.

After capture, birds were transported to Homer C. Thompson Vegetable Research Farm (HTVR Farm, Cornell University, Department of Entomology) located in Freeville (approximately 3 km and 33 km from the Freeville and Spencer marshes, respectively). The blackbirds were placed in 1.25×0.9×0.6 m cages (maximum of six birds per cage) in a covered building. Birds were provided ad libitum with grit, water, and a seed mixture consisting of commercial wild bird seed (Favorite™ Feathered Friends® Wild Bird Food, Agway, Syracuse, N.Y.), cracked corn, millet, milo, sunflower seed, and sunflower hearts. Fresh ears of sweet corn were offered daily to ensure acclimation to this food source. One week after capture, birds were banded, and randomly assigned to one of four named groups such that each group comprised two sub-adults of each sex in 1997, and one adult male and two sub-adults in 1998. Birds remained in these groups for the duration of the study.

In 1997, each group of birds was then moved outside to one of four outdoor portable pens that were used in the field trials. These 1.9×1.9×1.9 m pens were open-bottomed, and their sides and tops were made of netting. The pens were placed in the experimental sweet corn plot over plants that had mature ears (we selected a variety of sweet corn that was less than 2 m tall at its maximum height). The bottom of each pen was sealed with soil and stones to prevent birds from escaping. The birds were kept in these pens for acclimation with an ad libitum supply of birdseed and water. In 1998, the birds were kept in holding cages between capture and the start of the trials (between 7 and 20 days).

In both years, birds were weighed before the first trial, and after the last one to monitor weight changes and overall health. After the study, the blackbirds were released where captured. The methods for the capture and maintenance of the blackbirds for this study, and the experimental protocol were approved by the Center for Research Animal Resources, Cornell University (Protocol number 97-70).

Study Plots and Treatment of Sweet Corn

Approximately 0.2 ha of sweet corn (Seneca Horizon Yellow cultivar) was planted at the HTVR Farm during the first three weeks of May. Seed was sown at 1-week intervals to ensure that ears were at approximately the same stage of maturity over the course of the trials. For each trial, two control and two treatment pens (described above) were used containing three or four blackbirds. The position of the pens for each trial and their treatment class was randomly determined. For plants assigned to fiber treatment, ears were sprayed with a commercially available polymer. Attempts were made to completely enclose each ear with fiber.

For the 1997 trials, fibers were generated in situ by fabricating a small-scale prototype machine that was mounted on a portable backpack, and fibers were produced of ethylene vinyl acetate (EVA) (Elvax 200W or 205W; Dupont Polymers, Wilmington, Del.) by a melt extrusion process. Hydraulic pressure was used to extrude molten EVA through a small orifice and the fibers were carried to the target by a stream of air. The melt-extrusion apparatus consisted of a metal reservoir (160 by 100 mm) that was heated to 150-180° C. and pressurized to about 172.4 kPa with carbon dioxide. The pressure forced the molten EVA through a 2-mm inner diameter (ID) nozzle orifice located near the base of the reservoir. Fibers from this prototype unit were white and ranged from 20 to 250 μm in diameter. Constraints imposed by this spraying equipment prevented complete coverage of the sweet corn ears with fiber so commercial equipment was used in subsequent studies to generate the EVA fibers.

In 1998, the commercial equipment used to generate the EVA fibers was made by ITW Dynatec (Hendersonville, Tenn.). This equipment was used to generate the EVA fibers in situ, again by melt extrusion. This equipment was designed to apply hot melt glue in industrial settings, and permitted easy generation of a range of fiber characteristics by varying temperature, pressure, and nozzle configuration. The equipment consisted of a Dynamini adhesive supply unit fitted with a pneumatic piston pump, and a 3.7 m Dynaflex hose and a Dynagun hot melt applicator Model 155 fitted with a 0.787 mm Dynaswirl nozzle orifice. The unit required an air compressor and was powered in the field by a generator. The EVA fibers generated ranged from 5 to 50 μm in diameter. An all-terrain vehicle and trailer was used to move this equipment through the study plot.

Trials

Ten trials were conducted in 1997 and eight in 1998. Trials were conducted in the mornings (one per day) between September 18 and October 10. The trial time was 4 h 30 min; trials started between 9:30 am and noon, and ended between 1:30 and 4:00 pm. Prior to each trial, the pens were moved to enclose either control or treatment plots of sweet corn, and the number of corn ears present in each pen was recorded. These numbers were similar in 1997 (mean=18; SD=1.60) and 1998 (mean=17, SD=0.99). Each year, bird groups were assigned to either treatment or control pens before the first trial. For the next trial, groups that had been assigned to treatment pens were shifted to control pens and vice versa. This alternating pattern was continued for the remaining trials.

In both years, feed was removed from the holding cages 1 h prior to a trial. Then the blackbirds were captured and moved to the appropriate field pen. The birds were left undisturbed during the 4 h 30 min trial period. At the end of the trial, all sweet corn ears were removed from each pen and the number that had husk damage and/or kernel damage was recorded. For ears with kernel damage, the percentage of kernels removed was visually estimated. For treated ears, the percent fiber coverage was also estimated and the fiber weight was recorded. The blackbirds were provided with seed and water ad libitum after the trial.

Statistical Analysis

The effect of treatment on the percentage of the total ears per pen that suffered husk damage and kernel damage was examined using the PROC MIXED procedure of SAS version 7.0 (SAS, Inc., Cary, N.C.). The effects of treatment and trial day were examined in the AVOVA model. Because of differences in the composition of bird groups between years, the data for each year were analyzed separately. The effect of fiber coverage on the percentage of kernels damaged per treated ear in the 1997 study (when fiber coverage varied) was examined by using a SAS PROC MIXED analysis of data from all treated ears. Bird groupings were also evaluated for possible effects. This analysis was not conducted for the 1998 data because there was minimal variability in fiber coverage. The field data were not transformed because this did not improve the normality of the distributions.

Results

In 1997, the average fiber coverage rate was 60% (N=340 ears, S.E.±1.05), and the mean fiber weight per ear was 5.12 g (S.E.±0.18). In 1998, the percent cover was far higher, with a mean of 98% (N=272 ears, S.E.±0.29), and mean fiber weight per ear was 11 g (S.E.±0.18) (FIG. 1). In 1997, when there was considerable variability in the fiber coverage, fiber cover had a significant effect on percent kernel damage per ear (F_{1,320}=18.63, P<0.0001). The experimental procedure had no apparent effect on blackbird health, as pre- and post-trial weights were similar each year (1997: t=−1.569, P=0.12; 1998: t=−1.07, P=0.304). However, the mean weight of study birds was less in 1997 (47.3 g) than in 1998 (63.8 g) (t=−5.52, P<0.0001) due to differences in age (each pen contained one adult male in 1998).

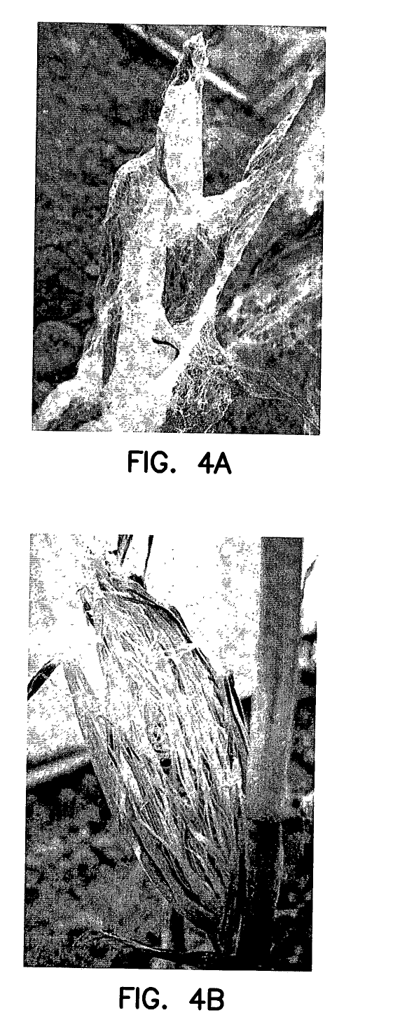

FIGS. 4A and 4B provides photographs illustrating the effects of fiber covering on corn ears. As shown, ears that were covered with a fibrous barrier of the invention sustained significantly less damage (FIG. 4A) than did corn ears that had no such fiber barrier (FIG. 4B). Treatment of ears with fiber reduced the percentage of ears per pen that had husk damage in both the 1997 (F_{1,26}=9.41, P=0.005) and 1998 (F_{1,20}=5.94, P=0.0242) studies. The percentage of ears with husk damage per year (combining data from pens and trial days) was 10% lower for treated than for control ears in 1997, and 12% lower for treated ears in 1998 (Table 44).

Similarly, fiber treatment reduced the percentage of ears per pen with kernel damage in both 1997 (F_{1,26}=11.55, P=0.0022) and 1998 (F_{1,20}=8.09, P=0.0100). Combining the data from all trials for each year, the percentage of ears with kernel damage was 10% lower for treated than control ears in 1997, and 11% lower for treated ears in 1998 (Table 44).

TABLE 44
Percentage of all sweet corn ears that suffered husk
and/or kernel damage by caged blackbirds
in trials conducted in Freeville, NY,
between 18 September and 10 October
in 1997 (10 trials) and 1998 (8 trials).

| | Year | | | | | |
|---|---|---|---|---|---|---|
| | 1997 | | | 1998 | | |
| | Control | Treated | | Control | Treated | |
| | N = 367 | N = 364 | P | N = 266 | N = 272 | P |
| % ears with | 41 | 31 | 0.005 | 91 | 79 | 0.024 |
| husk damage | | | | | | |
| % ears with | 33 | 23 | 0.002 | 26 | 15 | 0.010 |
| kernel damage | | | | | | |

Once birds had gained access to the kernels, there was no difference in the percentage of kernels damaged per ear whether or not the ear was treated. The mean percent kernels damaged per ear was 20% for both control (N=122, SE±1.7) and treated (N=83, SE±1.8) ears in 1997, and in 1998 was 19% for control (N=69, SE±1.8) and 23% for treated ears (N=41, SE±3.0).

Spraying sweet corn ears with obstructive non-woven fibers reduced the percentage of ears that suffered either husk or kernel damage as a result of blackbird feeding. However, once blackbirds gained access to the kernels on an ear, fiber treatment had no effect on the mean percentage of kernels damaged per ear, which ranged from 20-23% for both control and treated ears in 1997 and 1998. It appeared that once the birds had broken through the husk, the EVA fibers tended to fall away easily from around the torn area.

Fiber coverage varied considerably among ears in 1997, and had a significant effect on percent kernel damage per ear (P<0.0001). In 1998, the coverage was higher and considerably less variable (mean coverage 60%, SE±11.05 in 1997 versus 98%, SE±0.29 in 1998). Therefore the 1998 fiber treatment should have been more effective in reducing damage than the 1997 treatment. However, the percentage of control cars that received husk damage in 1998 (91%) was more than double that in 1997 (41%), suggesting that feeding pressures in the pens was higher in the second year. Composition of the bird groups contributed to differences in feeding pressure. In 1997, groups comprised four sub-adults, whereas in 1998 they comprised one adult male and two sub-adults. Adult male blackbirds are capable of causing a greater amount of damage to sweet corn ears than sub-adults because they are more experienced in feeding on corn, and have greater body and bill strength. The bills of adult males are generally longer, which may have increased the ability of the adults to access kernels, because this appears to be positively related to gape size (Bernhardt et al., 1987).

Averaging the results from the two study years, fiber treatment reduced the percentage of ears that had any kernel damage by 10.5%. For a New York grower, a 10.5% increase in yield may convert into a saving of $401/ ha for fresh corn, and $101/ha for processed corn (NYSDAM, 2000).

### EXAMPLE 8

### Fibrous Barrier Control of Deer

Many deer repellent sprays that are available commercially lose repellency over time. This Example illustrates that the use of sprayable fibers as a long-term carrier for a deer repellent can provide an effective solution to this problem.

Methods

Field Trial. Beans were planted two seeds to a pot (Agway Blue Lake Bush variety) in the late summer. Each pot was treated as a single experimental unit, though there may actually have been two plants in a single pot. Four sites with previous deer damage were selected for this study. Two sites were in Cayuga Heights and the other two sites were near Varna, near Ithaca, N.Y.

Three forms of ethylene vinyl acetate (EVA) spray were tested: (1) EVA only, (2) EVA with capsaicin oleoresin, and (3) EVA with BGR (Big Game Repellent, containing putrescent egg solids). Two non-fiber treatments were used for comparison: Hinder, a commercial, soap-based deer repellent, and a control group that received no repellent at all. There were nine replicates for each of the five treatments totaling forty-five beans plants per site. With four sites, thirty-six plants of each treatment type were tested in this study.

The concentration of the capsaicin oleoresin in the EVA was approximately 200,000 Scoville Heat Units (SHUs). SHUs are a standard measure of the relative heat for capsaicin. The concentration of the EVA/BGR mix was 12 g BGR to 800 g fiber. Hinder was diluted 1:25 with water and sprayed on the plant according to label directions.

The plants were placed in the field and were treated with fiber and the Hinder formulations the next day. Each plant was placed at least four meters away from the next plant. Marker flags staked each pot to the ground to prevent it from being knocked over and to limit buffeting by the wind. The location of each treatment within a site was chosen randomly. Each pot was marked with a colored tag identifying which treatment the plant had received.

The plants were checked daily for the next eight days and on four or five additional days during the next three weeks. The amount of damage any plant received was recorded on a categorical scale (0-10%, 11-25%, 26-50%, 51-75%, and 76-100% damage). The date was recorded when each plant achieved each level of damage. Notes were also taken on the health of the plant (insect damage, frost), and plants were watered if necessary. Approximately sixteen days after plants were placed in the fields, two sites suffered severe frost damage and the damaged plants were removed from the study a few days later. However, the other plants were left for more observations.

Results

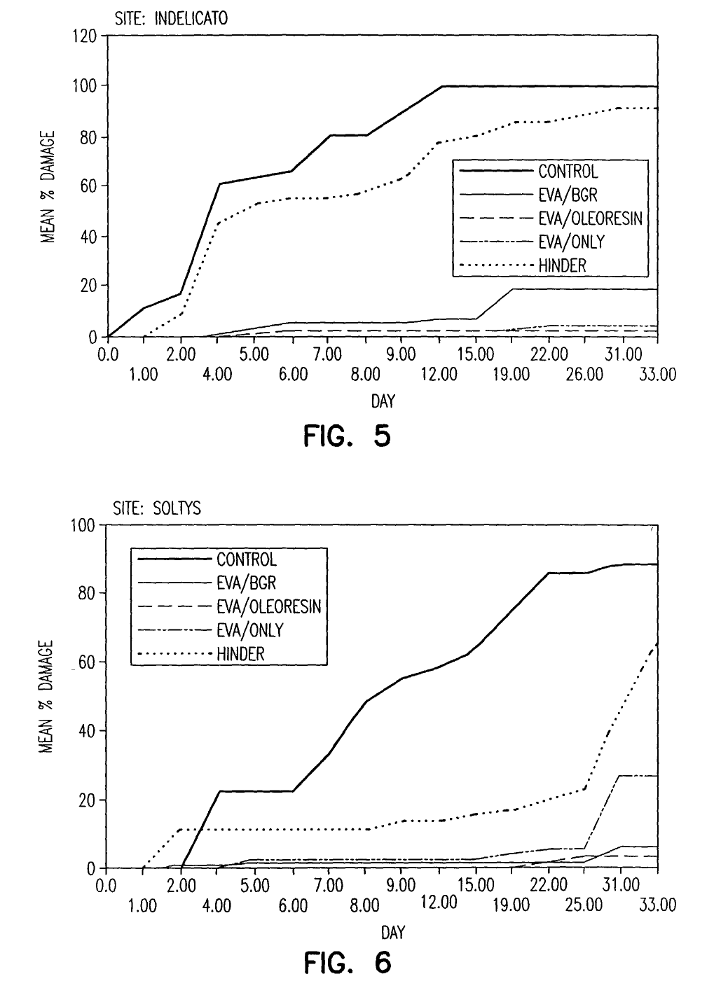

Table 45 and FIGS. 5 and 6 provide data illustrating that treatment with fiber compositions of the invention dramatically reduces the damage to bean plants by deer. The Tukey multiple comparisons indicated that control and Hinder treatments were significantly different from all other treatments and also from each other (Table 45, P<0.01). However, the three EVA treatments (plain fiber, capsaicin fiber and BGR fiber) were not significantly different from each other.

TABLE 45
% DAMAGE
Tukey HSD^{a,b}

| | | Subset | | |
|---|---|---|---|---|
| Treatment | N | 1 | 2 | 3 |
| EVA/Oleoresin | 288 | 1.14% | | |
| EVA/only | 288 | 3.81% | | |
| EVA/BGR | 288 | 5.22% | | |
| Hinder | 288 | | 38.31% | |
| Control | 288 | | | 60.16% |
| Sig. | | .404 | 1.000 | 1.000 |

Means for groups in homogeneous subsets are displayed.
Based on Type III Sum of Squares
The error term is Mean Square(Error) = 786.381.
^{a}Uses Harmonic Mean Sample Size = 288.000.
^{b}Alpha = .05.

Control plants received the greatest damage (>80% loss by day 33). Hinder-treated plants also sustained significantly more deer damage (>60% loss by day 33) than those treated with EVA. In contrast, plants receiving EVA fiber treatment (EVA only, EVA/BGR, and EVA/capsaicin) sustained significantly less damage over time (e.g., <10% for EVA-only treatment to day 25). The ANOVA model indicated a significant difference among treatments at days 8 and day 33 (P<0.05).

EVA fibers alone were equally effective compared to EVA fibers containing capsaicin or BGR. This result may be due to inactivation or loss of the capsaicin or BGR. However, EVA fibers were highly effective as a deer repellent, providing a significant improvement over Hinder, a commercially available deer repellent.

Literature Cited and Incorporated Herein by Reference:

Abacus Concepts, 1989, Super ANOVA: accessible general linear modeling. Abacus Concepts, Berkeley, Calif.

Askham, L. R., 2000. Efficacy of the aerial application of methyl anthranilate in reducing bird damage to sweet corn, sunflowers, and cherries. Proc. Vertebr. Pest Conf. 19, 22-25.

Avery, M. L., Decker, D. G., Humphrey, J. S., Laukert, C. C., 1996. Mint plant derivatives as blackbird feeding deterrents. Crop Prot. 15, 461-464.

Avery, M. L., Humphrey, J. S., Decker, D. G., McGrane, A. P., 1999. Seed color avoidance by captive red-winged blackbirds and boat-tailed grackles. J. Wildl. Manage. 63, 1003-1008.

Bernhardt, G. E., Vanallsburg, L., Dolbeer, R. A., 1987.Blackbird and starling feeding behavior on ripening corn ears. Ohio J. Sci. 87, 125-129.

Bollinger, E. K., Caslick, J. W., 1985. Factors influencing blackbird damage to field corn. J. Wildl. Manage. 49, 1109-1115.

Brugger, K. E.; P. Nol, and C. L. Phillips., 1993, Sucrose repellency to European starlings: will high-sucrose cultivars deter bird damage to fruit?, Ecol. Appl. 3:256-261.

Burbutis, P. P., and Lesiewicz, D. S.; 1973. Exclusion as a means of control of the European Corn Borer in Sweet Peppers. J. Econ. Entomol. 67: 97-98.

Carroll, K. A., C. R. Harris, and P. E. Morrison. 1983. Resistance shown by a parathion-resistant onion maggot (Diptera: Anthomyiidae) strain to some other insecticides. Can. Entomol. 115: 1519-1522.

Carruth, L. A., 1936, Experiments for the control of larvae of Heliothis obsolete Fabr. On western Long Island during 1935. J. Econ. Entomol. 29: 205-209.

Chalfant, R. B., C. A. Jaworski, A. W. Johnson, and D. R. Summer. 1977. Reflective film mulches, millet barriers, and pesticides: Effects on watermelon mosaic virus, insects, nematodes, soil-borne fungi, and yield of yellow summer squash. J. Amer. Hort. Sci. 102: 11-15.

Clark, L., and J. R. Mason, 1993 Interaction between sensory and post-gestional repellents in starlings: methyl anthranilate and sucrose. Ecol. Appl. 3:262-270.

Conover, M. R., 1984. Comparative effectiveness of Avitrol, exploders, and hawk-kites in reducing blackbird damage to corn. J. Wildl. Manage. 48, 109-116.

Conover, M. R., Dolbeer, R. A., 1989. Reflecting tape fails to reduce blackbird damage to ripening cornfields. Wildl. Soc. Bull. 17, 441-443.

Conway, D. E., B. D. McCraw, J. E. Motes, and J. L. Sherwood. 1989. Evaluations of mulches and row covers to delay virus diseases and their effects on yield of yellow squash. Applied Agricultural Res. 4: 201-207.

Cowles, R. S. and J. R. Miller. 1992. Diverting Delia antiqua (Diptera: Anthomyiidae) oviposition with cull onions: field studies on planting depth and a greenhouse test of the stimulo-deterrent concept. Environ. Entomol. 21: 453-460.

Cowles, R. S., J. E. Keller, and J. R. Miller. 1989. Pungent spices, ground red pepper, and synthetic capsaicin as onion fly ovipositional deterrents. J. Chem. Ecol. 15: 719-730.

Cummings, J. L., Mason, J. R., Otis, D. L., Heisterberg, J. F., 1991. Evaluation of dimethyl and methyl anthranilate as a Canada goose repellent on grass. Wildl. Soc. Bull. 19, 184-190.

Curtis, P. D., Fargione, M. J., Richmond, M. E, Frantz, S. C., Trimarchi, C. V., 1993. 1993 pest management recommendations for control of vertebrates. NY State Coll. of Agric. and Life Sci., Cornell University, Ithaca, N.Y. (27 pp).

Curtis, P. D., Merwin, I. A., Pritts, M. P., Peterson, D. V., 1994. Chemical repellents and plastic netting for reducing bird damage to sweet cherries, blueberries, and grapes. Hort. Sci. 29, 1151-1155.

Dolbeer, R. A., 1990. Ornithology and integrated pest management: red-winged blackbirds Agelaius phoeniceus and corn. Ibis 132, 309-322.

Dolbeer, R. A., Clark, P. P., Woronecki, P. P., Seamans, T. W., 1992. Pen tests of methyl anthranilate as a bird repellent in water. Proc. Eastern Wildl. Damage Control Conf. 5, 112-116.

Dolbeer, R. A., Ingram, C. R., Seubert, J. L., Stickley, A. R., Mitchell, R. T., 1976. 4-aminopyridine effectiveness in sweet corn related to blackbird population density. J. Wildl. Manage. 40, 64-570.

Dolbeer, R. A., Stehn, R. A., 1983. Population status of blackbirds and starlings in North America, 1966-81. Proc. East. Wildl. Damage Control Conf. 1, 51-61.

Dolbeer, R. A., Woronecki, P. P., Mason, J. R., 1988. Aviary and field evaluations of sweet corn resistance to damage by blackbirds. J. Amer. Soc. Hort. Sci.113, 460-464.

Dolbeer, R. A., Woronecki, P. P., Stehn, R. A., 1986. Resistance of sweet corn to damage by blackbirds and starlings. J. Amer. Soc. Hort. Sci. 111, 306-311.

Eckenrode, C. J., M. L. Hessney, W. C. Kain, and A. G. Taylor. 2000. Onion maggot control, 1999. Arthrop. Manag. Tests 25: 126.

Evans, A., S. Wratten, C. Frampton, S. Causer and M. Hamilton. 1997. Row covers: effects of wool and other materials on pest numbers, microclimate, and crop quality. J. Econ. Entomol. 90(6): 1661-1664.

Finch, S. 1980. Chemical attraction of plant-feeding insects to plants. Appl. Biol. 5: 67-143.

Finch, S. 1989. Ecological considerations in the management of Delia pest species in vegetable crops. Annu. Rev. Entomol. 34: 117-137.

Finch, S. and A. R. Thompson. 1992. Pests of cruciferous crops. In R. G. McKinlay (ed.) Vegetable crop pests. CRC Press, Boca Raton, Fla.

Finch, S., M. E. Cadoux, C. J. Eckenrode, and T. D. Spittler. 1986a. Appraisal of current strategies for controlling onion maggot (Diptera: Anthomyiidae) in New York State. J. Econ. Entomol. 79: 736-740.

Finch, S., C. J. Eckenrode, and M. E. Cadoux. 1986b. Behavior of onion maggot (Diptera: Anthomyiidae) in commercial fields treated regularly with parathion sprays. J. Econ. Entomol. 79: 107-113.

Fuller-Perrine, L. D. and M. E. Tobin. 1992. A cost-effective method for applying and removing bird-exclusion netting in commercial vineyards. Proc. East. Wildl. Damage Control Conf. 5:111.

Harris, M. O. and J. R. Miller. 1983. Color stimuli and oviposition behavior of the onion fly, Delia antiqua (Diptera: Anthmyiidae). Ann. Entomol. Soc. Am. 76: 766-771.

Harris, M. O. and J. R. Miller. 1991. Quantitative analysis of ovipositional behavior: effects of a host-plant chemical on the onion fly (Diptera: Anthomyiidae). J. Insect Beh. 4(6): 773-792.

Harris, C. R. and H. J. Svec. 1976. Onion maggot resistance to insecticides. J. Econ. Entomol. 69: 617-620.

Harris, C. R., R. A. Chapman, R. F. Morris, and A. B. Stevenson. 1988. Enhanced soil microbial degradation of carbofuran and fensulfothion—a factor contributing to the decline in effectiveness of some soil insect control programs in Canada. J. Environ. Sci. Health. 23: 301-316.

Hayden, J. and E. Grafius. 1990. Activity of Cyromazine on onion maggot larvae (Diptera: Anthomyiidae) in the soil. J. Econ. Entomol. 83: 2398-2400.

Himelrick, D., Battling the birds: the war without Mesurol. East. Grape Grower and Winery News (August/September 1985):22-25.

Hintz, J. V., Dyer, M. I., 1970. Daily rhythm and seasonal change in the summer diet of adult red-winged blackbirds. J. Wildl. Manage. 34, 789-799.

Hoffmann, M. P., P. Schwartz and J. M. Baird. 2000. Non-Woven fiber barriers for control of agricultural pests. U.S. Pat. No. 6,052,943.

Hoffmann, M. P., L. T. Wilson and F. G. Zalorn. 1991a Area-wide pheromone trapping of Helicoverpa zea and Heliothis phloxiphaga (Lepidoptera: Noctuidae) in the Sacramento and San Joaquin Valleys of Calif. J. Econ. Entomol. 84: 902-911.

Hough-Goldstein, J. A. 1987. Tests of spun polyester row cover as a barrier against seedcorn maggot (Diptera: Anthomyiidae) and cabbage pest infestations. J. Econ. Entomol. 80: 768-772.

Liburd, O. E., R. A. Casagrande and S. R. Alm. 1998. Evaluation of various color hydromulches and weed fabric on broccoli insect populations. J. Econ. Entomol. 91(1): 256-262.

Knittle, C. E., Guarino, J. L., Bray, O. E., Cummings, J. L., Ouellette, M. R., 1976. Protecting ripening sweet corn from blackbirds in Wisconsin with 4-aminopyridine. Bird Control Semin. Proc. 7, 188-194.

Mott, D. F., 1976. Protecting ripening sweet corn from blackbirds in Idaho with 4-amino pyridine. Bird Control Semin. Proc. 7, 195-199.

NYSDAM, New York State Dept. of Agriculture and Markets, 2000. New York Agricultural Statistics 1999-2000. New York Agricultural Statistics Service, NYSDAM, Division of Statistics, Albany, New York (106 pp).

Martinez, A. M., D. Goulson, J. W. Chapman, P. Caballero, R. D. Cave, and T. Williams. 2000. Is it feasible to use optical brightener technology with a baculovirus bioinsecticide for resource-poor maize farmers in Mesoamerica. Biol. Contr. 17: 174-181.

Martinez, del Rio, C. 1990. Dietary, phylogenetic, and ecological correlates of intestinal sucrase and maltase activity in birds. Physiol. Zool. 63:987-1011.

Matthews-Gehringer, D. and J. Hough-Goldstein. 1988. Physical barriers and cultural practices in cabbage maggot (Diptera: Anthomyiidae) management on broccoli and Chinese cabbage. J. Econ. Entomol. 81(1): 354-360.

McDonald R. S. and M. K. Sears. 1992. Assessment of larval feeding damage of the cabbage maggot (Diptera: Anthomyiidae) in relation to oviposition preference on canola. J. Econ. Entomol. 85(3): 957-962.

Mitchell, E. R. 1978. Relationships of planting date to damage by corn earworms in commercial sweet corn in north central Florida, Fla. Entomol. 61: 251-255.

Moyer, D. D. 1993. New pifalls for the CPB. pp. 94-95. In Proc. of the 1993 New York State Vegetable Conference. Syracuse, N.Y.

Oatman, E. R. 1966. Parasitization of corn earworm eggs on sweet corn silk in southern California, with notes on larval infestations and predators. J. Econ. Entomol. 59: 830-835.

Ott, L. 1984. An introduction to statistical methods and data analysis, 2nd ed. PWS, Boston, Mass.

Perring, T. M., R. N. Royalty, and C. A. Farrar. Floating row covers for exclusion of virus vectors and the effect on disease incidence and yield of cantaloupe. J. Econ. Entomol. 82: 1709-1715.

Pfadt, R. E. 1978. Fundamentals of applied entomology. MacMillan Publ. Co. New York. 798 pp.

Pike, K. S. and D. Allison. 1987. Effects on two spotted spider mites of insecticides applied to sweet corn for control of corn earworn. J. Agric. Entomol. 4: 327-332.

Prokopy, R. J. and E. D. Owens. 1983. Visual detection of plants by herbivorous insects. Ann. Rev. Entomol. 28: 337-364.

Prokopy, R. J., R. H. Collier, and S. Finch. 1983. Visual detection of host plants by cabbage root flies. Ent. exp. appl. 34: 85-89.

Schalk, J. M., C. S. Creighton, R. L. Fery, W. R. Sitterly, B. W. Davis, T. L. McFadden, and A. Day. 1979. Reflective mulches influences insect control and yield in vegetables. J. Amer. Hort. Sci. 104: 759-762.

Skinner, G. and S. Finch. 1986. Reduction of cabbage root fly (Delia radicum) damage by protective discs. Ann. Appl. Biol. 108: 1-10.

Stivers, L. 1999a. FQPA Crop Profile: Cabbage and other crucifers in New York. http://pmep.cce.cornell.edu/fqpa/crop-profiles/cabbage.html.

Stivers, L. 1999b. FQPA Crop Profile: Onions in New York. http://pmep.cce.cornell.edu/fqpa/crop-profiles/onion.html.

Straub, R. W. and B. Emmett. 1992. Pests of monocotyledon crops. In R. G. McKinlay (ed.) Vegetable crop pests. CRC Press, Boca Raton, Fla. 406 pp.

Tuttle, A. F., D. N. Ferro and K. Idoine. 1988. Role of visual and olfactory stimuli in host finding of adult cabbage root flies, Delia radicum. Entomol. exp. appl. 47: 37-44.

Wells, O. S. and J. B. Loy. 1985. Row covers for intensive vegetable production. Univ. of New Hampshire, Cooperative Extension Service.

Whitfield, G. H., R. I. Carruthers, D. L. Haynes. 1985. Phenology and control of the onion maggot (Diptera: Anthomyiidae) in Michigan onion production. Agric. Ecosyst. Environ. 12: 189-200.

Yudin, L. S., B. E. Tabashnik, W. C. Mitchell, and J. J. Cho. 1991. Effects of mechanical barriers on distribution of thrips (thysanoptera: Thripidae) in lettuce. J. Econ. Entomol. 84: 136-139.

The foregoing description has been directed to particular embodiments of the invention in accordance with the requirements of the Patent Statutes for the purposes of illustration and explanation. It will be apparent, however, to those skilled in this art that many modifications and changes will be possible without departure from the scope and spirit of the invention. It is intended that the following claims be interpreted to embrace all such modifications and changes.

What is claimed is:

1. A fibrous pest behavior-modifying composition comprising a non-woven fiber and a pest behavior-modifying compound covalently attached or stably adsorbed to the fiber.

2. The composition of claim 1 wherein the fiber comprises low density polyethylene, high density polyethylene, poly(ethylene glycol), poly(ethylene oxide), vinyl acetate, urethane, polyester, graphite, silicone, neoprene, disoprene, poly(vinyl alcohol), poly(vinylpyrrolidone), poly(ethyloxazoline), poly(ethylene oxide)-co-poly(propylene oxide) copolymer, poly (lactide-co-glycolide), polyglycolides, polylactides, poloxamine, carboxymethyl cellulose, hydroxyalkylated cellulose, hydroxyethyl cellulose, hydroxypropyl methylcellulose, polysucrose, polyacrylic acids, polyacrylamides, alyplastic glycols, polyaromatic acids, polyurethane, polyactic acid, polyamides, polyanhydrides, polycaprolactone, polycarbonate, polydioxanone, polyester, polyester-water dispersible, polyether-block copolyamide, polyhydroxyalkanotes, polyolefin, polyolefins, polyorthoesters, polyoxyethylene, polypropylene, polystyrene, polytrimethylene, perephthalate, rayon-non dispersible, hyaluronic acid, dextran, graphite, heparin sulfate, chondroitin sulfate, heparin, alginate, gelatin, collagen, albumin, ovalbumin, or starch.

3. The composition of claim 1 wherein the fiber comprises ethylene vinyl acetate.

4. The composition of claim 1 wherein the fiber is biodegradable.

5. The composition of claim 1 wherein the behavior-modifying compound is a pheromone, allomone, kairomone, capsaicin, a complex sugar, a phenolic compound, a monoterpenoid, dill, paprika, black pepper, catnip oil, chili powder, ginger, caffeine, red pepper or capsaicin oleoresin.

6. The composition of claim 1 wherein the behavior-modifying compound is an antifeedant, bird repellent, chemosterilant, insect attractant, insect repellent, mammal repellent, or mating disrupter.

7. A fibrous pesticide composition comprising a non-woven fiber and a pesticide covalently attached or stably adsorbed to the fiber.

8. The composition of claim 7 wherein the fiber comprises low density polyethylene, high density polyethylene, poly(ethylene glycol), poly(ethylene oxide),vinyl acetate, urethane, graphite, silicone, neoprene, disoprene, poly(vinyl alcohol), poly(vinylpyrrolidone), poly(ethyloxazoline), poly(ethylene oxide)-co-poly(propylene oxide) copolymer, poly (lactide-co-glycolide), polyglycolides, polylactides, poloxamine, carboxymethyl cellulose, hydroxyalkylated cellulose, hydroxyethyl cellulose, hydroxypropyl methylcellulose, polysucrose, polyacrylic acids, polyacrylamides, alyplastic glycols, polyaromatic acids, polyurethane, polyactic acid, polyamides, polyanhydrides, polycaprolactone, polycarbonate, polydioxanone, polyester, polyester-water dispersible, polyether-block copolyamide, polyhydroxyalkanotes, polyolefin, polyorthoester, polyoxyethylene, polypropylene, polystyrene, polytrimethylene, perephthalate, rayon-non dispersible, hyaluronic acid, dextran, graphite, heparin sulfate, chondroitin sulfate, heparin, alginate, gelatin, collagen, albumin, ovalbumin, or starch.

9. The composition of claim 7 wherein the fiber comprises ethylene vinyl acetate.

10. The composition of claim 7 wherein the fiber is biodegradable.

11. The composition of claim 7 wherein the pesticide is an acaricide, algicide, avicide, bactericide, fungicide, herbicide, insecticide, mating disrupter, molluscicide, nematicide, rodenticide, or virucide.

12. The composition of claim 7 wherein the pesticide is Bifonazole, Binapacryl, Bis(p-chlorophenoxy)methane, Bisphenol A, Bitertanol, Bromacil, Bromadiolone, Bromethalinlin, Bromophos, Bromopropylate, Bupirimate, Busulfan, Butrylin, Cambendazole, Candicidin, Candidin, Captan, Carbaryl, Carbendazim, Carbophenothion, Chloramben, Chloramphenacol, Chloranil, Chlorbetamide, Chlordimeform, Chlorfenac, Chlorphenesin, Chlorpyrifos, Chlorsulfuron or Chlorothion.

13. The composition of claim 7 wherein the pesticide is a Bacillus thuringiensis endotoxin polypeptide.

14. The composition of claim 7 wherein the pesticide is an insecticide.

15. The composition of claim 14 wherein the insecticide is abamectin, allosamidin, doramectin, emamectin, eprinomectin, ivermectin, milbemectin, selamectin, spinosad, thuringiensin, calcium arsenate, copper acetoarsenite, copper arsenate, lead arsenate, potassium arsenite, or sodium arsenite; botanical insecticides such as anabasine, azadirachtin, d-limonene, nicotine, pyrethrins, cinerin I, cinerin II, jasmolin I, jasmolin II, pyrethrin I, pyrethrin II, quassia, rotenone, ryania, sabadilla, bendiocarb, carbaryl, benfuracarb, carbofuran, carbosulfan, decarbofuran, furathiocarb, dimetan, dimetilan, hyquincarb, pirimicarb, alanycarb, aldicarb, aldoxycarb, butocarboxim, butoxycarboxim, methomyl, nitrilacarb, oxamyl, tazimcarb, thiocarboxime, thiodicarb, thiofanox, allyxycarb, aminocarb, bufencarb, butacarb, carbanolate, cloethocarb, dicresyl, dioxacarb, ethiofencarb, fenethacarb, fenobucarb, isoprocarb, methiocarb, metolcarb, mexacarbate, promacyl, promecarb, propoxur, trimethacarb, xylylcarb, dinex, dinoprop, dinosam, barium hexafluorosilicate, cryolite, sodium fluoride, sodium hexafluorosilicate, sulfluramid, amitraz, chlordimeform, formetanate, formparanate, acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, methyl bromide, methylchloroform, methylene chloride, naphthalene, phosphine, sulfuryl fluoride, tetrachloroethane, borax, calcium polysulfide, mercurous chloride, potassium thiocyanate, sodium thiocyanate, bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron, triflumuron, epofenonane, fenoxycarb, hydroprene, kinoprene, methoprene, pyriproxyfen, triprene, juvenile hornone I, juvenile hormone II, juvenile hormone III, chromafenozide, halofenozide, methoxyfenozide, tebufenozide, α-ecdysone, ecdysterone, diofenolan, precocene I, precocene II, precocene III, dicyclanil, bensultap, cartap, thiocyclam, thiosultap, flonicamid, clothianidin, dinotefuran, thiamethoxam, nitenpyram, nithiazine, acetamiprid, imidacloprid, nitenpyram, thiacloprid, bromo-DDT, camphechlor, DDT, pp′-DDT, methoxychlor, pentachlorophenol, aldnrn, chlorbicyclen, chlordane, chlordecone, dieldrin, dilor, endosulfan, endrin, heptachlor, isobenzan, isodrin, kelevan, mirex, bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, schradan, tetrachlorvinphos, dioxabenzofos, fosmethilan, phenthoate, acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, isothioate, malathion, methacrifos, oxydemeton-methyl, oxydeprofos, oxydisulfoton, phorate, sulfotep, terbufos, thiometon, amidithion, cyanthoate, dimethoate, ethoate-methyl, formothion, mecarbam, omethoate, prothoate, sophamide, vamidothion, chlorphoxim, phoxim, phoxim-methyl, azamethiphos, coumaphos, coumithoate, dioxathion, endothion, menazon, morphothion, phosalone, pyraclofos, pyridaphenthion, quinothion, dithicrofos, thicrofos, azinphos-ethyl, azinphos-methyl, dialifos, phosmet, isoxazole, isoxathion, zolaprofos, chlorprazophos, pyrazophos, chlorpyrifos, chlorpyrifos-methyl, butathiofos, diazinon, etrimfos, lirimfos, pirimiphos-ethyl, pirimiphos-methyl, primidophos, pyrimitate, tebupirimfos, quinalphos, quinalphos-methyl, athidathion, lythidathion, methidathion, prothidathion, isazofos, triazophos, azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos, butonate, trichlorfon, mecarphon, fonofos, trichloronat, cyanofenphos, leptophos, crufomate, fenamiphos, fosthietan, mephosfolan, phosfolan pirimetaphos, acephate, isofenphos, methamidophos, propetamphos, dimefox, mazidox, mipafox, indoxacarb, acetoprole, ethiprole, fipronil, tebufenpyrad, tolfenpyrad, vaniliprole, acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, flufenerim, pyrimidifen, spiromesifen, chlorfenapyr, closantel, crotamiton, diafenthiuron, fenazaflor, fenoxacrim, flucofuron, hydramethylnon, isoprothiolane, malonoben, metoxadiazone, nifluridide, pyridaben, pyridalyl, rafoxanide, sulcofuron, triarathene or triazamate.

16. The composition of claim 7 wherein the pesticide comprises a bird repellent.

17. The composition of claim 16 wherein the bird repellent comprises anthraquinone, chloralose, complex sugars, copper oxychloride, diazinon, guazatine, methiocarb, trimethacarb or ziram.

18. The composition of claim 7 wherein the pesticide comprises a mammal repellent.

19. The composition of claim 18 wherein the mammel repellent is copper naphthenate, trimethacarb, zinc naphthenate, ziram, capsaicin, hydrogen sulfide.

20. The composition of claim 7 wherein the pesticide comprises a rodenticide.

21. The composition of claim 20 wherein the rodenticide is scilliroside, strychnine, brodifacoum, bromadiolone, coumachlor, coumafuryl, coumatetralyl, difenacoum, difethialone, flocoumafen, warfarin, chlorophacinone, diphacinone, pindone, arsenous oxide, phosphorus, potassium arsenite, sodium arsenite, thallium sulfate, zinc phosphide, lindane, phosacetim, antu, bromethalin, chloralose, α-chlorohydrin, crimidine, ergocalciferol, fluoroacetamide, flupropadine, hydrogen cyanide, norbormide, pyrinuron, or sodium fluoroacetate.

22. The composition of claim 7 wherein the pesticide comprises an insect repellent.

23. The composiyion of claim 22 wherein the insect repellent is butopyronoxyl, dibutyl phthalate, diethyltoluamide, dimethyl carbate, dimethyl phthalate, ethohexadiol, hexamide, methoquin-butyl, methylneodecanamide, oxamate, or picaridin.

24. A method of deterring a vertebrate pest from damaging a plant or a structure comprising applying an effective amount of a fibrous barrier to the plant or the structure.

25. The method of claim 24 wherein the pest is a bird, rodent, or herbivore.

26. The method of claim 24 wherein the fibrous barrier comprises low density polyethylene, high density polyethylene, poly(ethylene glycol), poly(ethylene oxide),vinyl acetate, urethane, graphite, silicone, neoprene, disoprene, poly(vinyl alcohol), poly(vinylpyrrolidone), poly(ethyloxazoline), poly(ethylene oxide)-co-poly(propylene oxide) copolymer, poly (lactide-co-glycolide), polyglycolides, polylactides, poloxamine, carboxymethyl cellulose, hydroxyalkylated cellulose, hydroxyethyl cellulose, hydroxypropyl methylcellulose, polysucrose, polyacrylic acids, polyacrylamides, alyplastic glycols, polyaromatic acids, polyurethane, polyactic acid, polyamides, polyanhydrides, polycaprolactone, polycarbonate, polydioxanone, polyester, polyester-water dispersible, polyether-block copolyamide, polyhydroxyalkanotes, polyolefin, polyorthoester, polyoxyethylene, polypropylene, polystyrene, polytrimethylene, perephthalate, rayon-non dispersible, hyaluronic acid, dextran, graphite, heparin sulfate, chondroitin sulfate, heparin, alginate, gelatin, collagen, albumin, ovalbumin, or starch.

27. The method of claim 24 wherein the fibrous barrier comprises ethylene vinyl acetate.

28. The method of claim 24 wherein the fibrous barrier is biodegradable.

29. The method of claim 24 wherein the fibrous barrier is applied directly to the whole plant or the whole structure.

30. The method of claim 24 wherein the fibrous barrier is selectively applied to a part of the plant or a part of the structure.

31. The method of claim 24 wherein the fibrous barrier is applied to ground surrounding the plant or surrounding the structure.

32. The method of claim 24 wherein the fibrous barrier further comprises a behavior-modifying compound.

33. The method of claim 32 wherein the behavior-modifying compound is a pheromone, allomone, kairomone, capsaicin, a complex sugar, a phenolic, a monoterpenoid, dill, paprika, black pepper, catnip oil, chili powder, ginger, caffeine, red pepper or capsaicin oleoresin.

34. The method of claim 24 wherein the fibrous barrier further comprises a bird repellent.

35. The method of claim 34 wherein the bird repellent comprises anthraquinone, chloralose, complex sugars, copper oxychloride, diazinon, guazatine, methiocarb, trimethacarb or ziram.

36. The method of claim 24 wherein the fibrous barrier further comprises a mammal repellent.

37. The method of claim 36 wherein the mammel repellent is copper naphthenate, trimethacarb, zinc naphthenate, ziram, capsaicin, hydrogen sulfide.

38. The method of claim 24 wherein the fibrous barrier further comprises a rodenticide.

39. The method of claim 38 wherein the rodenticide is scilliroside, strychnine, brodifacoum, bromadiolone, coumachlor, coumafuryl, coumatetralyl, difenacoum, difethialone, flocoumafen, warfarin, chlorophacinone, diphacinone, pindone, arsenous oxide, phosphorus, potassium arsenite, sodium arsenite, thallium sulfate, zinc phosphide, lindane, phosacetim, antu, bromethalin, chloralose, ai-chlorohydrin, crimidine, ergocalciferol, fluoroacetamide, flupropadine, hydrogen cyanide, norbormide, pyrinuron, or sodium fluoroacetate.

40. The method of claim 24 wherein the fibrous barrier further comprises a pesticide.

41. The method of claim 40 wherein the pesticide is Bifonazole, Binapacryl, Bis(p-chlorophenoxy) methane, Bisphenol A, Bitertanol, Bromacil, Bromadiolone, Bromethalinlin, Bromophos, Bromopropylate, Bupirimate, Busulfan, Butrylin, Cambendazole, Candicidin, Candidin, Captan, Carbaryl, Carbendazim, Carbophenothion, Chloramben, Chloramphenacol, Chloranil, Chlorbetamide, Chlordimeform, Chlorfenac, Chlorphenesin, Chlorpyrifos, Chlorsulfuron or Chlorothion.

42. The method of claim 40 wherein the pesticide is slowly released into the environment.

43. The method of claim 24 wherein the fibrous barrier further comprises an insecticide.

44. The method of claim 43 wherein the insecticide is abamectin, allosamidin, doramectin, emamectin, eprinomectin, ivermectin, milbemectin, selamectin, spinosad, thuringiensin, calcium arsenate, copper acetoarsenite, copper arsenate, lead arsenate, potassium arsenite, or sodium arsenite; botanical insecticides such as anabasine, azadirachtin, d-limonene, nicotine, pyrethrins, cinerin T, cinerin II, jasmolin I, jasmolin II, pyrethrin I, pyrethrin II, quassia, rotenone, ryania, sabadilla, bendiocarb, carbaryl, benfuracarb, carbofuran, carbosulfan, decarbofuran, furathiocarb, dimetan, dimetilan, hyquincarb, pirimicarb, alanycarb, aldicarb, aldoxycarb, butocarboxim, butoxycarboxim, methomyl, nitrilacarb, oxamyl, tazimcarb, thiocarboxime, thiodicarb, thiofanox, allyxycarb, aminocarb, bufencarb, butacarb, carbanolate, cloethocarb, dicresyl, dioxacarb, ethiofencarb, fenethacarb, fenobucarb, isoprocarb, methiocarb, metolcarb, mexacarbate, promacyl, promecarb, propoxur, trimethacarb, xylylcarb, dinex, dinoprop, dinosam, barium hexafluorosilicate, cryolite, sodium fluoride, sodium hexafluorosilicate, sulfluramid, amitraz, chlordimeform, formetanate, formparanate, acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, methyl bromide, methylchloroform, methylene chloride, naphthalene, phosphine, sulfuryl fluoride, tetrachloroethane, borax, calcium polysulfide, mercurous chloride, potassium thiocyanate, sodium thiocyanate, bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron, triflumuron, epofenonane, fenoxycarb, hydroprene, kinoprene, methoprene, pyriproxyfen, triprene, juvenile hormone I, juvenile hormone II, juvenile hormone III, chromafenozide, halofenozide, methoxyfenozide, tebufenozide, α-ecdysone, ecdysterone, diofenolan, precocene I, precocene II, precocene III, dicyclanil, bensultap, cartap, thiocyclam, thiosultap, flonicamid, clothianidin, dinotefuran, thiamrethoxam, nitenpyram, nithiazine, acetamiprid, imidacloprid, nitenpyram, thiacloprid, bromo-DDT, camphechlor, DDT, pp′-DDT, methoxychlor, pentachlorophenol, aldrin, chlorbicyclen, chlordane, chlordecone, dieldrin, dilor, endosulfan, endrin, heptachlor, isobenzan, isodrin, kelevan, mirex, bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, schradan, tetrachlorvinphos, dioxabenzofos, fosmethilan, phenthoate, acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, isothioate, malathion, methacrifos, oxydemeton-methyl, oxydeprofos, oxydisulfoton, phorate, sulfotep, terbufos, thiometon, amidithion, cyanthoate, dimethoate, ethoate-methyl, formothion, mecarbam, omethoate, prothoate, sophamide, vamidothion, chlorphoxim, phoxim, phoxim-methyl, azamethiphos, coumaphos, coumithoate, dioxathion, endothion, menazon, morphothion, phosalone, pyraclofos, pyridaphenthion, quinothion, dithicrofos, thicrofos, azinphos-ethyl, azinphos-methyl, dialifos, phosmet, isoxazole, isoxathion, zolaprofos, chlorprazophos, pyrazophos, chlorpyrifos, chlorpyrifos-methyl, butathiofos, diazinon, etrimfos, lirimfos, pirimiphos-ethyl, pirimiphos-methyl, primidophos, pyrimitate, tebupirimfos, quinalphos, quinalphos-methyl, athidathion, lythidathion, methidathion, prothidathion, isazofos, triazophos, azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos, butonate, trichlorfon, mecarphon, fonofos, trichloronat, cyanofenphos, leptophos, crufomate, fenamiphos, fosthietan, mephosfolan, phosfolan pirimetaphos, acephate, isofenphos, methamidophos, propetamphos, dimefox, mazidox, mipafox, indoxacarb, acetoprole, ethiprole, fipronil, tebufenpyrad, tolfenpyrad, vaniliprole, acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, flufenerim, pyrimidifen, spiromesifen, chlorfenapyr, closantel, crotamiton, diafenthiuron, fenazaflor, fenoxacrim, flucofuron, hydramethylnon, isoprothiolane, malonoben, metoxadiazone, nifluridide, pyridaben, pyridalyl, rafoxanide, sulcofuron, triarathene or triazamate.

45. A method of deterring an invertebrate pest from biting or injuring a vertebrate animal comprising applying an effective amount of a fibrous barrier to the vertebrate animal.

46. The method of claim 45 wherein the invertebrate pest is a mosquito, fly, flea, louse, wasp, bee, tick, or leech.

47. The method of claim 45 wherein the fibrous barrier comprises low density polyethylene, high density polyethylene, poly(ethylene glycol), poly(ethylene oxide),vinyl acetate, urethane, graphite, silicone, neoprene, disoprene, poly(vinyl alcohol), poly(vinylpyrrolidone), poly(ethyloxazoline), poly(ethylene oxide)-co-poly(propylene oxide)copolymer, poly (lactide-co-glycolide), polyglycolides, polylactides, poloxamine, carboxymethyl cellulose, hydroxyalkylated cellulose, hydroxyethyl cellulose, hydroxypropyl methylcellulose, polysucrose, polyacrylic acids, polyacrylamides, alyplastic glycols, polyaromatic acids, polyurethane, polyactic acid, polyamides, polyanhydrides, polycaprolactone, polycarbonate, polydioxanone, polyester, polyester-water dispersible, polyether-block copolyamide, polyhydroxyalkanotes, polyolefin, polyorthoester, polyoxyethylene, polypropylene, polystyrene, polytrimethylene, perephthalate, rayon-non dispersible, hyaluronic acid, dextran, graphite, heparin sulfate, chondroitin sulfate, heparin, alginate, gelatin, collagen, albumin, ovalbumin, or starch.

48. The method of claim 45 wherein the fibrous barrier comprises ethylene vinyl acetate.

49. The method of claim 45 wherein the fibrous barrier is biodegradable.

50. The method of claim 45 wherein the fibrous barrier is selectively applied to a part of the vertebrate animal.

51. The method of claim 45 wherein the fibrous barrier is applied to soil surrounding a housing for the vertebrate.

52. The method of claim 45 wherein the fibrous barrier further comprises a behavior-modifying compound.

53. The method of claim 52 wherein the behavior-modifying compound is a pheromone, allomone or kairomone for the invertebrate pest.

54. The method of claim 45 wherein the fibrous barrier further comprises a pesticide.

55. The method of claim 54 wherein the pesticide is Bifonazole, Binapacryl, Bis(p-chlorophenoxy) methane, Bisphenol A, Bitertanol, Bromacil, Bromadiolone, Bromethalinlin, Bromophos, Bromopropylate, Bupirimate, Busulfan, Butrylin, Cambendazole, Candicidin, Candidin, Captan, Carbaryl, Carbendazim, Carbophenothion, Chloramben, Chloramphenacol, Chloranil, Chlorbetamide, Chlordimeform, Chlorfenac, Chlorphenesin, Chlorpyrifos, Chlorsulfuron or Chlorothion.

56. The method of claim 45 wherein the fibrous barrier further comprises an insect repellent.

57. The method of claim 56 wherein the insect repellent is butopyronoxyl, dibutyl phthalate, diethyltoluamide, dimethyl carbate, dimethyl phthalate, ethohexadiol, hexamide, methoquin-butyl, methylneodecanamide, oxamate, or picaridin.

58. The method of claim 45 wherein the fibrous barrier further comprises an insecticide.

59. The method of claim 58 wherein the insecticide is abamectin, allosamidin, doramectin, emamectin, eprinomectin, ivermectin, milbemectin, selamectin, spinosad, thuringiensin, calcium arsenate, copper acetoarsenite, copper arsenate, lead arsenate, potassium arsenite, or sodium arsenite; botanical insecticides such as anabasine, azadirachtin, d-limonene, nicotine, pyrethrins, cinerin I, cinerin II, jasmolin I, jasmolin II, pyrethrin I, pyrethrin II, quassia, rotenone, ryania, sabadilla, bendiocarb, carbaryl, benfuracarb, carbofuran, carbosulfan, decarbofuran, furathiocarb, dimetan, dimetilan, hyquincarb, pirimicarb, alanycarb, aldicarb, aldoxycarb, butocarboxim, butoxycarboxim, methomyl, nitrilacarb, oxamyl, tazimcarb, thiocarboxime, thiodicarb, thiofanox, allyxycarb, aminocarb, bufencarb, butacarb, carbanolate, cloethocarb, dicresyl, dioxacarb, ethiofencarb, fenethacarb, fenobucarb, isoprocarb, methiocarb, metolcarb, mexacarbate, promacyl, promecarb, propoxur, trimethacarb, xylylcarb, dinex, dinoprop, dinosam, barium hexafluorosilicate, cryolite, sodium fluoride, sodium hexafluorosilicate, sulfluramid, amitraz, chlordimeform, formetanate, formparanate, acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, methyl bromide, methylchloroform, methylene chloride, naphthalene, phosphine, sulfuryl fluoride, tetrachloroethane, borax, calcium polysulfide, mercurous chloride, potassium thiocyanate, sodium thiocyanate, bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron, triflumuron, epofenonane, fenoxycarb, hydroprene, kinoprene, methoprene, pyriproxyfen, triprene, juvenile hormone I, juvenile hormone II, juvenile hormone III, chromafenozide, halofenozide, methoxyfenozide, tebufenozide, α-ecdysone, ecdysterone, diofenolan, precocene I, precocene II, precocene III, dicyclanil, bensultap, cartap, thiocyclam, thiosultap, flonicamid, clothianidin, dinotefuran, thiamethoxam, nitenpyram, nithiazine, acetamiprid, imidacloprid, nitenpyram, thiacloprid, bromo-DDT, camphechlor, DDT, pp′-DDT, methoxychlor, pentachlorophenol, aldrin, chlorbicyclen, chlordane, chlordecone, dieldrin, dilor, endosulfan, endrin, heptachlor, isobenzan, isodrin, kelevan, mirex, bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, schradan, tetrachlorvinphos, dioxabenzofos, fosmethilan, phenthoate, acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, isothioate, malathion, methacrifos, oxydemeton-methyl, oxydeprofos, oxydisulfoton, phorate, sulfotep, terbufos, thiometon, amidithion, cyanthoate, dimethoate, ethoate-methyl, formothion, mecarbam, omethoate, prothoate, sophamide, vamidothion, chlorphoxim, phoxim, phoxim-methyl, azamethiphos, coumaphos, coumithoate, dioxathion, endothion, menazon, morphothion, phosalone, pyraclofos, pyridaphenthion, quinothion, dithicrofos, thicrofos, azinphos-ethyl, azinphos-methyl, dialifos, phosmet, isoxazole, isoxathion, zolaprofos, chlorprazophos, pyrazophos, chlorpyrifos, chlorpyrifos-methyl, butathiofos, diazinon, etrimfos, lirimfos, pirimiphos-ethyl, pirimiphos-methyl, primidophos, pyrimitate, tebupirimfos, quinalphos, quinalphos-methyl, athidathion, lythidathion, methidathion, prothidathion, isazofos, triazophos, azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3, trifenofos, butonate, trichlorfon, mecarphon, fonofos, trichloronat, cyanofenphos, leptophos, crufomate, fenamiphos, fosthietan, mephosfolan, phosfolan pirimetaphos, acephate, isofenphos, methamidophos, propetamphos, dimefox, mazidox, mipafox, indoxacarb, acetoprole, ethiprole, fipronil, tebufenpyrad, tolfenpyrad, vaniliprole, acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin, transfluthrin, etofenprox, flufenprox, halfenprox, protrifenbute, silafluofen, flufenerim, pyrimidifen, spiromesifen, chlorfenapyr, closantel, crotamiton, diafenthiuron, fenazaflor, fenoxacrim, flucofuron, hydramethylnon, isoprothiolane, malonoben, metoxadiazone, nifluridide, pyridaben, pyridalyl, rafoxanide, sulcofuron, triarathene or triazamate.

60. A method of keeping molluscs away from a plant or a structure, which comprises applying an effective amount of a fibrous-mollusc deterrent around the plant or the structure.

61. The method of claim 60 wherein the mollusc is a slug or a snail.

62. The method of claim 60 wherein the fibrous-mollusc deterrent comprises low density polyethylene, high density polyethylene, poly(ethylene glycol), poly(ethylene oxide),vinyl acetate, urethane, polyester, graphite, silicone, neoprene, disoprene, poly(vinyl alcohol), poly(vinylpyrrolidone), poly(ethyloxazoline), poly(ethylene oxide)-co-poly(propylene oxide) copolymer, poly(lactide-co-glycolide), polyglycolides, polylactides, poloxamine, carboxymethyl cellulose, hydroxyalkylated cellulose, hydroxyethyl cellulose, hydroxypropyl methylcellulose, polysucrose, polyacrylic acids, polyacrylamides, alyplastic glycols, polyaromatic acids, polyurethane, polyactic acid, polyamides, polyanhydrides, polycaprolactone, polycarbonate, polydioxanone, polyester, polyester-water dispersible, polyether-block copolyamide, polyhydroxyalkanotes, polyolefin, polyolefins, polyorthoesters, polyoxyethylene, polypropylene, polystyrene, polytrimethylene, perephthalate, rayon-non dispersible, hyaluronic acid, dextran, graphite, heparin sulfate, chondroitin sulfate, heparin, alginate, gelatin, collagen, albumin, ovalbumin, or starch.

63. The method of claim 60 wherein the fibrous-mollusc deterrent comprises ethylene vinyl acetate or polyester.

64. The method of claim 60 wherein said fibrous-mollusc deterrent comprises bromoacetamide, calcium arsenate, cloethocarb, copper acetoarsenite, copper sulfate, fentin, metaldehyde, methiocarb, niclosamide, pentachlorophenol, sodium pentachlorophenoxide, tazimcarb, thiodicarb, tributyltin oxide, trifenmorph, trimethacarb or elemental copper.
